(19) United States
(12) Patent Application Publication
(10) Pub. No.: US 2026/0289320 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,059

(22) Filed: Mar. 14, 2026

(30) Foreign Application Priority Data
Mar. 19, 2025 (JP) 2025-045081

(51) Int. Cl. G06N 3/091; G06N 3/0475; G06V 30/19; H04L 51/02

(52) U.S. Cl. CPC G06N 3/091; G06N 3/0475; G06V 30/19127; H04L 51/02

(57) ABSTRACT

A system includes a processor that is configured to obtain information from publicly available sources on the Internet by using a web crawler, preprocess and filter the obtained information by using natural language processing techniques, and generate and input a prompt to a generative artificial intelligence model to instruct the generative artificial intelligence model to predict an attack plan in advance.

### CROSS-REFERENCE TO RELATED APPLICATION

This application is based on and claims priority under 35 USC 119 from Japanese Patent Application No. 2025-045081 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional competitive intelligence systems typically rely on manual collection of publicly available information and heuristic or rule-based analysis to infer potential competitive moves. Such approaches are time-consuming, difficult to scale as the volume and diversity of online information increase, and often fail to capture subtle or emerging patterns contained in unstructured text data. Furthermore, existing systems do not effectively leverage generative artificial intelligence models to proactively predict attack plans, such as future competitive strategies or market actions, based on continuously updated public information. As a result, an enterprise may not obtain timely and accurate forecasts of attack plans, and may be unable to prepare appropriate countermeasures in advance. There is therefore a need for a system that can automatically collect, preprocess, and filter large-scale public information, generate appropriate prompts, and utilize a generative artificial intelligence model to predict attack plans in advance with improved efficiency and accuracy.

### SUMMARY

In order to solve the above-described problems, the present invention provides a system comprising a processor, wherein the processor is configured to obtain information from publicly available sources on the Internet by using a web crawler, preprocess and filter the obtained information by using natural language processing techniques, and generate and input a prompt to a generative artificial intelligence model to instruct the generative artificial intelligence model to predict an attack plan in advance. In one aspect, the processor is further configured to filter the information based on specific keywords in order to efficiently collect publicly available information over an information communication network, thereby reducing noise and focusing the analysis on information that is highly relevant to potential attack plans. In another aspect, the processor is configured to train a model by using a past dataset and include a feedback loop for improving prediction accuracy, so that the system can adaptively refine the preprocessing, filtering, and prompt generation processes in response to actual prediction performance. By combining automated web crawling, natural language processing-based preprocessing and filtering, keyword-based selection, and a feedback-enhanced use of a generative artificial intelligence model, the system enables timely and accurate advance prediction of attack plans based on large-scale public information.

The term “system” refers to an arrangement of one or more hardware and/or software components that cooperate to execute the processing described in the claims, including at least a processor and any associated storage, communication, and input/output components.

The term “processor” refers to any hardware component or set of components capable of executing instructions, including but not limited to a central processing unit (CPU), a graphics processing unit (GPU), a digital signal processor (DSP), a microcontroller, an application-specific integrated circuit (ASIC), a field-programmable gate array (FPGA), or a combination thereof.

The term “publicly available sources on the Internet” refers to information resources that can be accessed over the Internet without requiring special authorization, including but not limited to websites, web pages, online news articles, blogs, product pages, press releases, and publicly accessible databases.

The term “web crawler” refers to a software program or module that automatically navigates and retrieves content from multiple web pages or websites by following hyperlinks or predetermined URLs, and that stores the retrieved content for subsequent processing.

The term “preprocess” refers to performing one or more operations on raw obtained information to convert it into a form suitable for further analysis, including but not limited to tokenization, normalization, language detection, part-of-speech tagging, entity recognition, and removal of stop-words or irrelevant content.

The term “filtering” refers to selecting, excluding, or weighting parts of the obtained information according to predetermined criteria, such as relevance, content type, length, language, or presence of specific keywords, to reduce noise and focus on information of interest.

The term “natural language processing techniques” refers to computational methods for analyzing and processing human language text, including but not limited to tokenization, stemming, lemmatization, syntactic parsing, semantic analysis, topic modeling, and named entity recognition.

The term “generative artificial intelligence model” refers to a machine learning model configured to generate outputs such as text or structured data based on input prompts, including but not limited to large language models, transformer-based models, autoregressive models, and other generative models trained on large corpora.

The term “prompt” refers to an input, typically expressed as natural language text or structured instructions, that is provided to a generative artificial intelligence model in order to specify a task, request a particular type of output, or guide the model to generate a prediction or response.

The term “attack plan” refers to a predicted strategy, action, or series of actions that a competitor or other entity may take in a market or technical context, including but not limited to product launches, pricing changes, marketing campaigns, or technology deployments, inferred based on analysis of publicly available information.

The term “information communication network” refers to any wired or wireless network capable of transmitting data between devices, including but not limited to the Internet, intranets, local area networks (LANs), wide area networks (WANs), mobile communication networks, and combinations thereof.

The term “specific keywords” refers to one or more predetermined words, phrases, or tokens that are used as criteria for selecting or excluding information, and that are chosen based on their relevance to potential attack plans, competitors, products, technologies, or markets.

The term “past dataset” refers to previously collected data, including historical publicly available information and corresponding labels or metadata, which is stored and used for training or updating one or more models in the system.

The term “train a model” refers to executing a machine learning process that adjusts parameters of a model based on a dataset so that the model can perform tasks such as classification, clustering, or prediction with improved accuracy.

The term “feedback loop” refers to a process in which outputs or performance metrics of the system, including prediction results and their evaluation, are fed back into one or more components of the system, such as preprocessing, filtering, prompt generation, or model parameters, to iteratively improve prediction accuracy over time.

The term “prediction accuracy” refers to the degree to which predicted attack plans or related outputs of the system match or approximate actual observed actions, events, or ground truth, as measured by one or more quantitative or qualitative evaluation metrics.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi®, Bluetooth®, and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

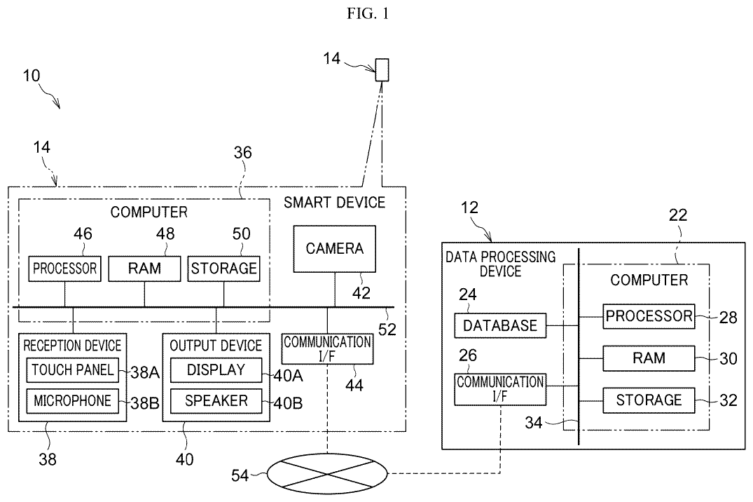

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

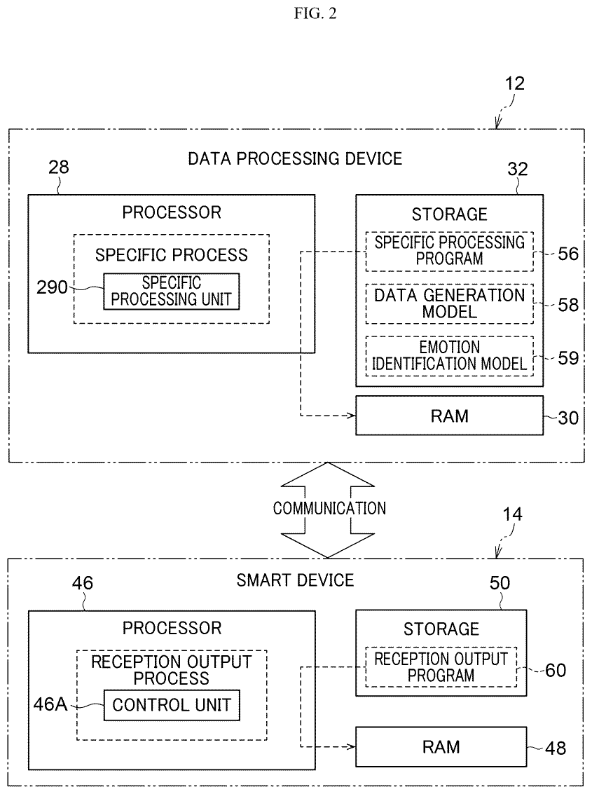

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional competitive intelligence and risk analysis systems largely rely on static rule-based pipelines in which public information is collected, heuristically filtered, and then manually interpreted by human analysts. Such systems suffer from several technical shortcomings in the context of modern large-scale information environments and generative artificial intelligence models.

First, when a processor merely collects public information using a crawler and applies simple keyword filtering, the resulting data often contains substantial noise and lacks the structured feature representation required for accurate machine learning-based prediction. This leads to inefficient use of computational resources, degraded prediction performance, and the need for repeated manual curation of datasets.

Second, known systems do not tightly integrate predictive models and generative AI models in a manner that is technically optimized. In typical architectures, a generative AI model is invoked with manually written, static prompt sentences that do not reflect the current prediction outputs or the detailed structure of the underlying data. As a result, the generative AI model may generate responses that are misaligned with the actual prediction state of the system, causing inconsistent behavior and limiting the usefulness of the system for automated decision support.

Third, conventional systems lack a technical feedback mechanism that unifies user interaction, predictive modeling, and prompt optimization. User evaluations or corrections, if collected at all, are not systematically fed back into (i) the training of the predictive model or (ii) the generation process of prompt sentences for the generative AI model. Consequently, the system cannot continuously adapt its internal models and prompt construction logic in response to changing data distributions, user preferences, or evolving competitive environments, and this results in suboptimal learning efficiency and reduced robustness of the overall computer-implemented process.

Fourth, existing competitive analysis tools often provide only static dashboards, where visualization logic is disconnected from the predictive pipeline and the generative AI components. This separation makes it difficult to automatically generate context-aware visualization data and natural language explanations that are consistently synchronized with model outputs and user-specified analysis conditions, thereby increasing cognitive load for users and reducing the effectiveness of the human-computer interaction.

Therefore, there is a need for a computer-implemented system that technically improves the way a processor (i) acquires, filters, and structures public information for machine learning-based prediction, (ii) derives prediction information for attack plans of other entities, (iii) dynamically generates and updates prompt sentences for a generative AI model based on prediction information and classification results, and (iv) incorporates user feedback into a unified feedback loop to continuously improve both prediction accuracy and prompt suitability. Such a system should provide improved computational efficiency, enhanced alignment between predictive and generative components, and a technically superior user interaction paradigm compared with conventional rule-based or manually configured systems.

The specific processing by the specific processing unit 290 of the data processing device 12 in Example 1 is realized by the following means.

The present invention provides a server comprising a processor configured to receive, from a terminal, identification information of an information acquisition target and analysis conditions, automatically collect public information over an information communication network based on the analysis conditions, perform text analysis processing and natural language processing on the collected public information to remove unnecessary information and extract useful information corresponding to predetermined temporal and topical conditions, convert the extracted useful information into structured data suitable for machine learning processing, calculate, by using a trained prediction model and based on the structured data, a plurality of candidate future actions of another entity and an occurrence probability corresponding to each candidate future action to generate prediction information for specifying an attack plan of the other entity, classify the public information based on the analysis conditions and generate input features for the prediction model from classification results, generate, based on the prediction information, the classification results, and the analysis conditions, an input sentence including a dynamically updated prompt sentence for causing a generative AI model to predict or explain the attack plan of the other entity, transmit the input sentence to the generative AI model, acquire explanation text information or strategy proposal information from the generative AI model, generate visualization data based on the prediction information and the explanation text information or the strategy proposal information, output display screen data accessible from the terminal, and further acquire, store, and use user evaluation information or correction instruction information as learning data for relearning of the prediction model and for optimization of prompt sentence generation logic. This enables a technically improved, end-to-end computer-implemented pipeline in which public information is transformed into structured machine-learning-ready data, predictive models and generative AI models are tightly integrated via dynamically optimized prompt sentences, visualization and explanation outputs are automatically synchronized with prediction results and user-specified conditions, and a unified feedback loop continuously enhances prediction accuracy, prompt suitability, and overall system performance on conventional computing hardware.

The term “public information” refers to information that is accessible over an information communication network without authentication tied to a specific individual or organization, including but not limited to web pages, news articles, press releases, reports, and other online content available to the general public.

The term “information communication network” refers to a wired or wireless communication infrastructure through which digital data is transmitted between computing devices, including but not limited to the Internet, wide area networks, and local area networks.

The term “terminal” refers to an information processing device operated by a user to send requests to, and receive responses from, a server, including but not limited to a personal computer, a tablet device, a smartphone, or any similar client device equipped with a display and a communication interface.

The term “identification information of an information acquisition target” refers to data indicating one or more sources or entities from which public information is to be collected, including but not limited to network addresses, resource locators, or identifiers of organizations, products, or topics.

The term “analysis conditions” refers to parameters that define how public information is to be collected, filtered, analyzed, or presented, including but not limited to time ranges, topic words, target entities, categories, and thresholds for selecting or grouping data.

The term “information searching process” refers to a sequence of computer-implemented operations for locating and acquiring public information from an information communication network based on analysis conditions, including but not limited to web crawling, automated retrieval, and link traversal processes.

The term “text analysis processing” refers to processing for analyzing character strings contained in public information, including but not limited to tokenization, pattern matching, keyword extraction, and regular expression matching.

The term “natural language processing” refers to processing by which a computer interprets, transforms, or analyzes text expressed in a human language, including but not limited to language detection, morphological analysis, part-of-speech tagging, named-entity recognition, topic classification, and semantic similarity analysis.

The term “unnecessary information” refers to portions of collected public information that do not satisfy the analysis conditions, such as text unrelated to specified topics or outside specified time ranges, and that are therefore removed or ignored by the system.

The term “useful information” refers to portions of collected public information that satisfy the analysis conditions, including temporal and topical constraints, and that are selected for further processing, prediction, or presentation.

The term “structured data” refers to data organized into a machine-readable format with explicitly defined fields or attributes, such as records, tables, or feature vectors, suitable for input to a machine learning model.

The term “machine learning processing” refers to computational procedures in which a model is trained, updated, or executed using data to infer patterns or make predictions, including but not limited to supervised learning, unsupervised learning, and reinforcement learning.

The term “trained prediction model” refers to a machine learning model whose internal parameters have been adjusted by training with historical data so as to output prediction results, such as probabilities of future actions of another entity, when presented with input features.

The term “candidate future actions” refers to possible actions that may be taken by another entity in the future, such as launching a product, changing a price, entering a market, or any other strategically relevant behavior.

The term “occurrence probability” refers to a numerical value indicating a likelihood that a particular candidate future action will occur, as computed by a prediction model based on structured data.

The term “another entity” refers to an actor whose behavior is subject to prediction by the system, including but not limited to an organization, a business competitor, or any other subject of analysis.

The term “attack plan” refers to a combination of predicted future actions of another entity and their associated characteristics, such as timing and target domain, which together represent a strategic behavior pattern of the other entity.

The term “prediction information” refers to data indicating results of prediction performed by the trained prediction model, including but not limited to candidate future actions, occurrence probabilities, and related time information.

The term “classification results” refers to outputs of a classification process applied to public information, including but not limited to labels or categories assigned to information items based on topics, time ranges, entities, or other analysis conditions.

The term “input features” refers to numerical or categorical values derived from structured data and classification results that are fed into a prediction model as explanatory variables.

The term “generative information processing model” refers to a model configured to generate text or other content based on an input sentence, including but not limited to a generative AI model or a large language model that outputs explanation text information or strategy proposal information.

The term “prompt sentence” refers to a portion of an input sentence provided to a generative information processing model that specifies a task, context, or constraint for generation, and that is constructed or updated based on prediction information and classification results.

The term “input sentence” refers to a textual input, including a prompt sentence and optionally structured data expressed in textual or serialized form, that is transmitted to a generative information processing model to request generated output.

The term “explanation text information” refers to text generated by a generative information processing model that explains prediction information, such as reasons for predicted actions or implications of an attack plan.

The term “strategy proposal information” refers to text generated by a generative information processing model that suggests possible responsive or defensive strategies based on prediction information and analysis conditions.

The term “visualization data” refers to data representing graphical or tabular forms of prediction information and generated text, including but not limited to chart parameters, layout information, and serialized figures, which can be rendered on a display.

The term “display screen data” refers to data formatted for presentation on a display device of a terminal, including but not limited to markup data, style data, script data, and embedded visualization data.

The term “user evaluation information” refers to information indicating a user's assessment of prediction information, explanation text information, or strategy proposal information, including but not limited to ratings, selections, confirmations, or approval indicators.

The term “correction instruction information” refers to information indicating user-provided corrections or adjustments to prediction information, explanation text information, or strategy proposal information, including but not limited to edits, overrides, or alternative selections.

The term “learning data” refers to data used for training or updating a prediction model or for optimizing prompt sentence generation, including but not limited to structured data, labels, user evaluation information, and correction instruction information.

The term “relearning” refers to a process in which a prediction model or prompt generation logic is retrained or updated using additional learning data to improve performance.

The term “feedback processing” refers to a sequence of operations in which user evaluation information or correction instruction information is incorporated into learning data, used for relearning, and thereby applied to adjust a prediction model or prompt generation logic, so as to continuously improve prediction accuracy and prompt suitability.

In one embodiment, a server cooperates with one or more terminals operated by a user to implement a system for predicting attack plans of another entity based on public information, and for generating explanation text information or strategy proposal information using a generative AI model. The server includes at least one processor, a memory storing programs and data structures, a non-transitory storage device, and a network interface connected to an information communication network such as the Internet. The terminal includes a processor, a display, an input interface, and a network interface.

The server executes, under control of stored programs, a plurality of functional modules, including an information acquisition module, a text processing module, a feature generation module, a prediction module, a generative AI interaction module, a visualization module, and a feedback management module. The server stores the modules and related configuration data in a storage device such as a magnetic disk, a solid-state drive, or a network-attached storage, and loads executable instructions into main memory when operating.

The server uses a web crawler implemented with a general-purpose programming language, such as Python, and may utilize libraries such as a hypertext retrieval library, a document object model parsing library (for example, a general-purpose HTML parsing library comparable to BeautifulSoup), and a dedicated crawling framework (for example, a framework comparable to Scrapy). The server operates the crawler on general-purpose computing hardware, such as an x86-compatible server running a general-purpose operating system.

The server acquires public information by transmitting hypertext transfer protocol requests to remote content servers, receiving hypertext documents, and storing the received documents in a raw document repository in the storage device. The server maintains, for each document, a record including a uniform resource locator, a timestamp, a title string, a body string, and metadata such as an inferred entity identifier and a content category. The server represents this record as a structured data object, for example as a row of fields in a relational database or as a document in a document-oriented database.

The server performs text analysis processing and natural language processing on the stored documents by using text processing libraries, such as regular expression engines, a tokenization library, and a natural language toolkit comparable to a widely available open-source NLP framework. The server normalizes text by converting characters to a uniform encoding (for example, UTF-8), lowercasing alphabetic characters, removing markup tags, and eliminating punctuation not required for analysis. The server segments the text into tokens and applies part-of-speech tagging and named-entity recognition to identify names of organizations, products, and markets. The server calculates term frequencies, inverse document frequencies, and derived scores such as TF-IDF values, and classifies documents into topic categories, such as “product launch,” “market entry,” or “price change,” using a trained classifier.

The server converts the processed text and metadata into structured data suitable for machine learning processing. The server uses a data analysis library comparable to a tabular data frame library (for example, a library similar to Pandas) and a numerical computation library (for example, a library similar to NumPy) to construct a feature matrix. The server encodes categorical attributes, such as entity identifiers, product categories, and content sources, into numeric feature vectors using one-hot encoding or label encoding. The server embeds textual fields using vectorization methods, such as TF-IDF vectorization or dense embedding vectors computed by a pre-trained language representation model. The server thereby produces, for each document or aggregated time window, a feature vector that represents both content and context of the public information.

The server applies a trained prediction model implemented using a machine learning library, such as a library comparable to a general-purpose machine learning toolkit (for example, scikit-learn) or a deep learning framework (for example, TensorFlow or an equivalent framework). In one embodiment, the server uses a gradient-boosted decision tree model or a random forest model to compute probabilities for a discrete set of candidate future actions of another entity. In another embodiment, the server uses a neural network model, such as a feedforward neural network including an input layer receiving a concatenated feature vector, one or more hidden layers with rectified linear unit activation functions, and an output layer with softmax activation to output normalized probabilities for multiple action classes.

The server trains the neural network model by initializing weights, defining a loss function such as categorical cross-entropy, and performing mini-batch stochastic gradient descent or a variant thereof (for example, Adam optimization). The server computes gradients by backpropagation and updates weights based on the gradient and a learning rate parameter. The server optionally performs regularization, such as dropout in hidden layers or L2 weight decay, to reduce overfitting. The server stores trained weight parameters in the storage device so that the model can be reloaded without retraining.

The server uses the trained prediction model to compute, for each relevant entity and time window, occurrence probabilities for candidate actions such as “launch new product,” “enter new geographic region,” or “change pricing strategy.” The server aggregates results by entity and time horizon, storing, for each entity, a vector of action probabilities and associated temporal indices. The server represents this prediction information in a structured form, for example as a table with fields for entity identifier, action category, probability value, and time index.

The server generates a prompt sentence and an input sentence for communication with a generative AI model. The server constructs the prompt sentence based on the prediction information, classification results, and analysis conditions received from the terminal. For example, the server may generate a prompt sentence in natural language such as:
“Summarize the most probable attack plans of major competitors in the next quarter based on the following predicted probabilities of future actions.”

The server then appends a textual description of the prediction information, such as:
“For Competitor A: 75% probability of new product launch, 40% probability of market entry, 30% probability of price reduction.

For Competitor B: 80% probability of new product launch, 25% probability of market entry, 50% probability of price reduction.”

The server can generate other example prompt sentences, including:
“Predict how competitors are likely to react to our upcoming new product announcement in the European market, and suggest three defensive strategies we should consider.” or
“Given our current forecast that Competitor B has an 80% probability of announcing a new product next quarter, explain the potential impact on our market share and propose concrete countermeasures.”

The server concatenates the prompt sentence and the prediction information into an input sentence and transmits it to the generative AI model. The generative AI model may be hosted on a separate server or provided as a network-accessible service. The server uses an application programming interface over secure communication protocols to send the input sentence and to receive generated text. The generative AI model may be implemented as a transformer-based neural network with multiple attention layers, trained on a large corpus of text using unsupervised or semi-supervised learning. The server specifies model parameters such as temperature, maximum output length, and decoding strategy (for example, greedy decoding or top-k sampling) in the request.

The server receives explanation text information or strategy proposal information from the generative AI model and stores this information in association with the underlying prediction information. The server does not merely output this text as-is, but aligns it with technical structures in the system by tagging each generated sentence or paragraph with references to specific entities, time windows, and action categories. This structured association allows the server to manage large volumes of generated content efficiently, to avoid redundant calls, and to support incremental updates when prediction information changes.

The server generates visualization data for presentation on the terminal. The server uses a visualization library such as a graphing library comparable to Matplotlib or an interactive charting library comparable to Plotly to produce a representation suitable for rendering on a display device. The server constructs bar charts, line charts, or heatmaps in which axes represent entities, action categories, or time indices, and data values represent predicted probabilities or aggregated risk scores. The server adds annotations indicating key probabilities, such as an annotation reading “80% probability of new product launch in next quarter” above a corresponding bar. The server also generates layout information specifying chart dimensions, color schemes, and legends.

The server outputs display screen data, including markup language data, style data, script data, visualization parameters, and generated text, to the terminal. The terminal receives the display screen data and renders it using a web browser or a dedicated application. The terminal displays interactive elements, such as selection controls for time range, entity, and topic category, and relays user selections back to the server as updated analysis conditions. The terminal presents the explanation text information and strategy proposal information adjacent to or overlaid on corresponding visualization elements.

The server acquires user evaluation information and correction instruction information via the terminal. The user may indicate, through controls on the terminal, whether a particular predicted attack plan is plausible, whether a generated explanation is appropriate, or whether an alternative scenario should be considered. The server stores these evaluations and corrections as learning data linked to the corresponding structured data and model outputs. The server uses this learning data to perform relearning of the prediction model, for example by adding new labeled samples to the training dataset and retraining the model periodically or incrementally. The server may adjust loss function weights to emphasize samples with high user evaluation scores or to penalize predictions that received negative evaluations.

The server also optimizes prompt sentence generation logic using the learning data. The server stores pairs of prompt sentences and resulting model outputs, along with user evaluations, in a prompt history repository. The server analyzes which prompt patterns yield higher user satisfaction or lower disagreement with subsequent prediction results and adjusts its prompt construction rules accordingly. For example, the server may modify the structure of prompt sentences to include more explicit constraints, such as specifying the time horizon or requested number of strategy proposals, when user evaluations indicate that vague prompts result in less useful outputs.

The server thereby improves technical performance of the system in several ways. First, by converting unstructured public information into structured data and by generating optimized feature representations, the server improves prediction accuracy and reduces computational overhead in the prediction model. Second, by dynamically generating prompt sentences based on up-to-date prediction information and classification results, the server reduces the number of ineffective calls to the generative AI model, thereby decreasing communication load and processing time. Third, by incorporating feedback data from the user into both the prediction model and the prompt generation logic, the server adaptively tunes model parameters and prompt structures, which leads to reduced error rates, faster convergence of training processes, and improved consistency between predictive and generative components.

The server does not simply automate human reading and writing; instead, the server implements a non-conventional data flow and control scheme that is difficult to perform manually. For example, the server coordinates timing of web crawling, feature extraction, prediction, generative AI invocation, and feedback-based relearning according to availability of new data and evaluation signals, using scheduling logic and cache structures to prevent redundant reprocessing. The server maintains separate but linked data structures for raw documents, intermediate feature vectors, prediction outputs, generated texts, and user feedback, and updates these structures in a manner that supports incremental model updates without full pipeline recomputation.

In one variation, the server employs an alternative prediction model architecture, such as a recurrent neural network or a temporal convolutional network, that explicitly models sequences of public information over time to capture dynamic behavior of another entity. The server then uses context windows of historical features to predict future actions, further improving accuracy for time-dependent events. In another variation, the server deploys the generative AI model locally on specialized hardware, such as a graphics processing unit or a tensor processing unit, and manages memory and batch scheduling for input sentences to maximize throughput and minimize latency.

The server thus achieves technical effects such as faster processing of large volumes of public information, higher accuracy of predicted attack plans, reduced communication overhead between the server and external AI services through more targeted and efficient prompts, and improved manageability of data and model parameters via the feedback management module. These effects arise from the claimed configuration and interactions among the server, the prediction model, the generative AI model, the prompt sentence generation mechanism, and the feedback loop, rather than from mere automation of a human business process.

The terminal and the user cooperate with the server to realize the full functionality of the system. The terminal presents configuration interfaces for specifying analysis conditions, displays complex visualization data in an interactive form, and serves as an input channel for user feedback. The user interprets the visualized prediction information and generated strategies, adjusts analysis conditions, and provides evaluation and correction information. Through repeated operation, the user helps generate learning data that the server uses to refine its internal models and prompt generation logic, yielding a system whose internal technical performance improves over time on conventional computing hardware.

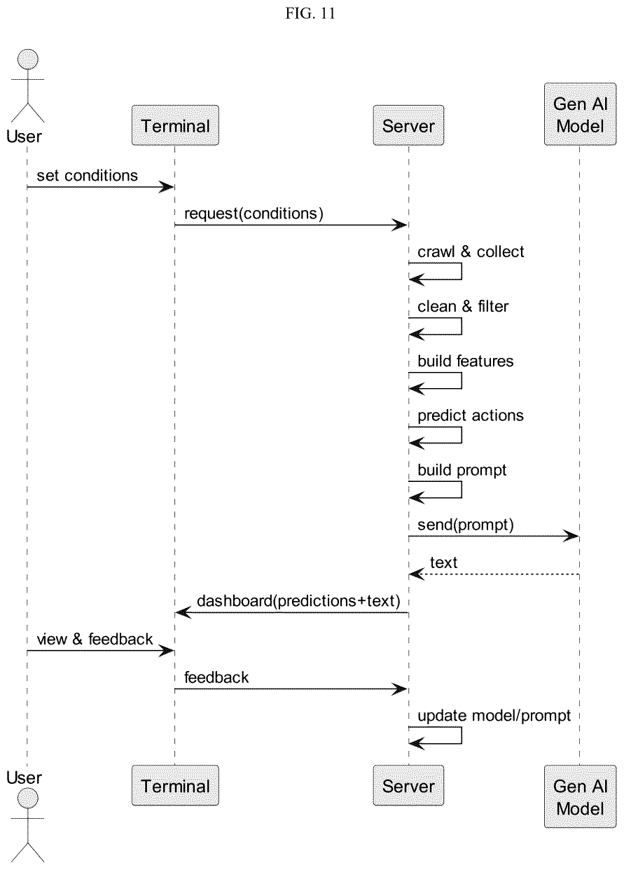

The following describes the processing flow using FIG. 11.

### Step 1

Server receives analysis conditions from the terminal.

Server accepts, as input, a request transmitted from the terminal, the request including at least analysis conditions such as target entities, a list of target URLs, a time range, and topic words. Server parses the request payload, extracts structured parameters (for example, strings for entity identifiers, a list of URL strings, start and end timestamps, and an array of topic word strings), and stores these parameters in a configuration data structure in memory. Based on the extracted parameters, server initializes internal control variables, such as crawling depth, refresh interval, and filtering thresholds, which are used in later processing. The output of this step is a normalized configuration object that defines how subsequent data acquisition and analysis are to be executed.

### Step 2

Server acquires public information from an information communication network.

Server receives, as input, the configuration object produced in Step 1, including the list of URLs and time range. Server launches a web crawler process that iterates over each URL, issues hypertext transfer protocol requests, and receives response documents. Server stores each response document, along with its URL, retrieval timestamp, and response headers, in a raw document repository in storage. Server further extracts initial metadata such as page title and content length by parsing the document headers and HTML structure. The output of this step is a collection of raw documents, each represented as a record containing at least a URL, a timestamp, a title string, a body string, and basic metadata.

### Step 3

Server performs text normalization and language-specific preprocessing.

Server receives, as input, the collection of raw documents from Step 2. Server converts character encodings to a unified format, such as UTF-8, removes markup tags and script segments, and normalizes whitespace. Server applies a tokenizer to split text into tokens, and uses language detection to discard documents not matching a target language condition specified in the configuration. Server generates, for each document, a cleaned text field and a token list. Server records this information in an intermediate text dataset. The output of this step is a cleaned document set where each document includes normalized text and token sequences suitable for further natural language processing.

### Step 4

Server filters documents based on analysis conditions and extracts useful information.

Server receives, as input, the cleaned document set from Step 3 and the analysis conditions, including topic words and time range. Server evaluates, for each document, whether the document's timestamp lies within the specified time range and whether the document text contains one or more topic words or semantically related terms determined by a similarity function. Server may use regular expressions and a natural language processing library to detect presence of key terms, named entities matching target entities, or topic categories. Server flags documents that satisfy the conditions as useful information and discards or deprioritizes documents that do not. Server stores only the selected documents in a filtered dataset. The output of this step is a filtered document set containing useful information corresponding to predetermined temporal and topical conditions.

### Step 5

Server generates structured data and feature vectors for machine learning.

Server receives, as input, the filtered document set from Step 4. Server constructs a tabular data structure in which each row corresponds to a document or an aggregated time window for a particular entity, and columns correspond to features such as token counts, TF-IDF scores, entity indicators, source type, and time-based attributes. Server applies encoding techniques to convert categorical attributes (for example, entity name, source category) into numeric vectors using one-hot encoding or label encoding. Server computes TF-IDF vectors or dense embeddings for the textual content using a text vectorization algorithm or a pre-trained embedding model. Server concatenates all numeric attributes into a feature vector for each row. The output of this step is a structured feature matrix and associated identifiers (for example, entity IDs and timestamps) stored in memory or in a feature repository.

### Step 6

Server executes a trained prediction model to compute candidate future actions.

Server receives, as input, the feature matrix from Step 5 and a trained prediction model previously stored in the storage device. Server loads model parameters into memory, configures runtime options (for example, batch size and computation device), and passes the feature matrix to the model as input. Server performs numerical operations such as matrix multiplications, non-linear activations, and probability normalization (for example, via softmax) to compute, for each entity and time context, a probability distribution over candidate future actions (for example, product launch, market entry, price change). Server writes prediction outputs into a prediction dataset that associates each entity and time index with a vector of occurrence probabilities. The output of this step is prediction information capturing candidate future actions and their occurrence probabilities.

### Step 7

Server aggregates and formats prediction information for downstream use.

Server receives, as input, the raw prediction dataset from Step 6. Server groups prediction records by entity and time window, and computes summary statistics such as the highest probability action, cumulative probabilities over action categories, and derived risk indicators. Server formats this prediction information into a structured representation that includes, for each entity, a ranked list of candidate actions with corresponding probabilities and optional confidence scores. Server stores this formatted prediction information in a prediction repository accessible to other modules. The output of this step is a consolidated prediction report structure used to generate prompt sentences and visualizations.

### Step 8

Server generates a prompt sentence and constructs an input sentence for a generative AI model.

Server receives, as input, the consolidated prediction report from Step 7 and the analysis conditions from Step 1. Server selects relevant segments of the prediction report (for example, top-k actions per entity with probabilities above a threshold) and converts them into textual descriptions. Server constructs a prompt sentence that describes the task for the generative AI model, such as summarization, risk explanation, or strategy proposal. For example, server may generate the following prompt sentence:
“Summarize the most probable attack plans of the main competitors in the next quarter based on the following predicted future actions and probabilities, and explain their potential impact on our product strategy.”

Server then appends a formatted text list of prediction results, such as:
“For Competitor A: 75% probability of a new product launch, 40% probability of market entry, 30% probability of a price reduction.

For Competitor B: 80% probability of a new product launch, 25% probability of market entry, 50% probability of a price reduction.”

Server concatenates the prompt sentence and the prediction descriptions into a single input sentence string. The output of this step is a fully constructed input sentence that serves as textual input to the generative AI model.

### Step 9

Server transmits the input sentence to a generative AI model and acquires generated text.

Server receives, as input, the input sentence from Step 8. Server forms a request message including the input sentence and generation parameters such as maximum output length, temperature, and decoding method. Server sends this request to a generative AI model through a network interface using an application programming interface. Server waits for a response and, when a response is received, parses the response to extract generated text segments, which may include explanation text information and strategy proposal information. Server stores the generated text in association with corresponding entities, time windows, and prediction identifiers. The output of this step is generated natural language content aligned with the prediction information.

### Step 10

Server generates visualization data combining prediction results and generated text.

Server receives, as input, the consolidated prediction report from Step 7 and the generated text obtained in Step 9. Server constructs visualization specifications, including chart types, axes, series values, labels, and annotations. Server maps predicted probabilities to graphical elements such as bar heights or line positions, and attaches textual annotations that may include excerpts from the generated explanation text or strategy proposals. Server organizes visualization specifications and generated text into a display screen data structure, such as a markup document with embedded scripts and serialized chart definitions. The output of this step is display screen data that encodes both visual and textual representations of prediction and analysis results.

### Step 11

Server transmits display screen data to the terminal.

Server receives, as input, the display screen data from Step 10. Server packages the data into a response message formatted for rendering by a terminal, including markup, style, script, and data payloads. Server transmits the response via a communication protocol to the terminal. The output of this step is a delivered response that enables the terminal to render an interactive dashboard reflecting current predictions and generative explanations.

### Step 12

Terminal renders the dashboard and accepts user interactions.

Terminal receives, as input, the response message sent by the server in Step 11. Terminal parses the markup, loads style definitions, and executes scripts to construct visual components such as charts, tables, and text panels on a display device. Terminal binds user interface controls (for example, selectors for entities and time ranges, buttons for requesting new analyses, and feedback controls) to event handlers that send subsequent requests to the server. Terminal presents generated explanation text and strategy proposals next to corresponding visualized predictions. The output of this step is a rendered dashboard with active user interface elements.

### Step 13

User reviews prediction information, generated text, and provides feedback.

User receives, as input, the visual and textual information displayed on the terminal in Step 12. User inspects charts, reads explanation text, and evaluates the plausibility and usefulness of the predicted attack plans and suggested strategies. User may perform operations such as selecting different entities, changing time ranges, or entering a custom prompt sentence (for example, “Based on the current predictions, propose three defensive strategies against a potential price reduction by Competitor B in the European market.”). User may also input evaluation signals (for example, approval or disapproval) or correction instructions for specific predictions or generated statements. The output of this step is user-generated input sent from the terminal back to the server.

### Step 14

Server records user feedback and updates learning data.

Server receives, as input, user feedback and custom prompts transmitted from the terminal in Step 13. Server associates each feedback item with corresponding prediction records and generated text identifiers and stores these associations in a feedback repository. Server transforms feedback into learning signals, such as labels or weights indicating correctness or usefulness of predictions and generated content. Server updates learning datasets for the prediction model and prompt sentence generation logic by appending new samples or adjusting sample importance weights. The output of this step is an enriched learning dataset that reflects user evaluations and corrections.

### Step 15

Server performs relearning and refines prediction and prompt generation logic.

Server receives, as input, the enriched learning dataset from Step 14. Server retrains or incrementally updates the prediction model by executing a training procedure with the new data, recalculating model parameters to minimize a loss function that may incorporate penalties for predictions that received negative feedback. Server evaluates performance on validation data and updates production model parameters if performance improves. Server also analyzes the relationship between prompt sentence patterns and feedback scores, and adjusts prompt construction rules or template parameters to enhance alignment between prompts and desired outputs. The output of this step is an updated prediction model and refined prompt generation logic that improve prediction accuracy and prompt suitability in subsequent executions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for monitoring external entities and predicting their future actions suffer from several technical limitations at the data processing and model orchestration level. First, typical web-crawling and analytics pipelines are designed as loosely coupled components that merely collect and store unstructured text, requiring human analysts or separate applications to interpret the data. As a result, the collected public information is not efficiently transformed into machine-usable representations, and the system cannot provide timely, automated inferences about future behavioral strategies of external entities.

Second, conventional predictive models operate on preprocessed data but do not integrate structured prediction outputs with natural language explanation generation in a unified, closed-loop architecture. In many systems, machine learning models output only numerical scores or categorical labels, while separate explanation tools, if present at all, are manually invoked or are not synchronized with the prediction model's input features and outputs. This decoupling leads to inconsistent explanations, increased latency, and redundant processing of the same input data.

Third, existing systems often lack a technically robust feedback mechanism that uses actual outcomes and generated explanations to update both the prediction model and the prompt design for generative artificial intelligence models. Without an integrated feedback loop, the system cannot effectively adapt to data drift, changing patterns in external entities'behavior, or deficiencies in the generated explanatory content. This results in degraded prediction accuracy over time and explanations that may not reflect the most relevant causal factors or impacts.

Fourth, there is a technical deficiency in selectively structuring, prioritizing, and distributing prediction and explanation data to client devices. Many systems simply push raw or minimally processed data to user interfaces, forcing client applications to perform heavy computation or heuristic filtering on resource-constrained devices. This causes unnecessary network traffic, increases client-side processing load, and delays the presentation of critical information to the user. Additionally, conventional notification mechanisms typically rely on simple event triggers without leveraging model-derived confidence and impact metrics, leading to either notification overload or missed critical events.

Accordingly, there is a need for an improved computer-implemented system and server that: (i) automatically collects public document information from an information communication network and efficiently converts such information into structured competitor trend data; (ii) applies a prediction model to generate attack plan information including confidence and impact metrics; (iii) automatically generates, manages, and utilizes prompt sentences for a generative artificial intelligence model to obtain consistent, context-aware natural language explanations; (iv) stores prediction and explanation data in a structured form suitable for efficient transmission to client devices; and (v) implements a feedback loop that refines both the prediction model and the prompt generation process based on actual outcomes, thereby improving the technical performance of the overall prediction and explanation pipeline.

The specific processing by the specific processing unit 290 of the data processing device 12 in Application Example 1 is realized by the following means.

The present invention provides a server comprising a processor configured to execute an information collection program to acquire document information as public information on an information communication network, execute a natural language processing program on the acquired document information to perform preprocessing including morphological analysis, term extraction, removal of unnecessary terms, and feature generation, and to filter the document information as competitor trend data, execute a machine learning program based on the competitor trend data to input the competitor trend data into a prediction model and to generate attack plan information including a prediction result regarding a future behavioral strategy of an external entity and confidence information and impact information associated with the prediction result, generate, based on the attack plan information and the competitor trend data, a prompt sentence for causing a generative artificial intelligence model including a generative language model to perform advance prediction of an attack plan and to generate an explanatory text regarding a reason and an impact of the attack plan, input the prompt sentence into the generative artificial intelligence model, and obtain explanation information in natural language from the generative artificial intelligence model, store the attack plan information and the explanation information as structured data in a storage device and transmit the structured data to a client device, determine importance based on the confidence information and the impact information included in the attack plan information and extract attack plan information that satisfies a predetermined condition as important attack plan information to generate notification data, and further execute a learning process on the prediction model using a historical data set including previously collected competitor trend data, corresponding actual behavioral results, and the explanation information obtained from the generative artificial intelligence model, and perform a feedback process that updates the prediction model and a generation process of the prompt sentence based on a difference between the attack plan information and the actual behavioral results. This enables an integrated, computer-implemented pipeline that improves the technical efficiency and accuracy of transforming unstructured network information into structured predictions and explanations, reduces processing and filtering overhead on client devices, enhances the timeliness and relevance of notifications by leveraging confidence and impact metrics, and continuously refines both predictive modeling and generative explanation behavior through a closed-loop feedback mechanism.

The term “information communication network” refers to a communication infrastructure including at least one wired or wireless network, such as the Internet, that enables electronic devices to exchange digital data using standardized communication protocols.

The term “public information” refers to information that is accessible via an information communication network without authentication specific to a particular user, including, for example, web pages, electronic documents, and publicly available data feeds.

The term “document information” refers to digital content obtained from public information sources, including at least text data and optionally metadata such as titles, timestamps, and source identifiers.

The term “information collection program” refers to a software module or set of instructions executable by a processor to send requests over an information communication network, receive responses, and extract document information from the responses.

The term “natural language processing program” refers to a software module or set of instructions executable by a processor to perform computational analysis on text data, including at least tokenization, morphological analysis, and term extraction.

The term “morphological analysis” refers to a process of decomposing text into minimal linguistic units and identifying grammatical attributes of each unit, such as part-of-speech, base form, and inflection.

The term “term extraction” refers to a process of identifying words or phrases in text that represent meaningful concepts, such as entities, events, or technical terms, for use in downstream analysis.

The term “removal of unnecessary terms” refers to a process of filtering out words or tokens that are not useful for analysis, such as stop words, common function words, or low-information symbols.

The term “feature generation” refers to a process of transforming preprocessed text or other data into numerical or categorical representations suitable for input to a machine learning model, such as vector representations, counts, or embeddings.

The term “competitor trend data” refers to structured or semi-structured data derived from document information that characterizes activities, events, or behaviors of external entities over time, and that is suitable for use as input to a prediction model.

The term “machine learning program” refers to a software module or set of instructions executable by a processor to apply a learned prediction model to input data and to output predicted values, categories, or probabilities.

The term “prediction model” refers to a data-driven model, trained using supervised, unsupervised, or semi-supervised learning techniques, that receives competitor trend data as input and outputs attack plan information.

The term “attack plan information” refers to structured information indicating a predicted future behavioral strategy of an external entity, including at least a predicted category of behavior and associated confidence information, and optionally impact information and a predicted time frame.

The term “external entity” refers to an organization, group, or other actor whose behavior is analyzed by the system and that is distinct from the operator or user of the system.

The term “confidence information” refers to a quantitative or qualitative indicator of reliability associated with a prediction result, such as a probability value, a score, or a confidence level.

The term “impact information” refers to data indicating an estimated degree or type of effect that a predicted behavioral strategy may have on a subject of interest, such as a market, product, or service.

The term “generative artificial intelligence model” refers to a trained computational model that, when provided with input data including a prompt sentence, generates new content such as natural language text consistent with patterns learned from training data.

The term “generative language model” refers to a type of generative artificial intelligence model specialized for processing and generating human language text based on input sequences of tokens.

The term “prompt sentence” refers to text provided as input to a generative artificial intelligence model, the text specifying at least one instruction, context, or question that conditions the model's generation of output text.

The term “explanatory text” refers to natural language text generated by a generative artificial intelligence model that describes at least a reason, cause, or rationale for a predicted attack plan and optionally its expected impact.

The term “explanation information” refers to data including at least explanatory text generated by a generative artificial intelligence model, and optionally additional metadata such as generation parameters or model identifiers.

The term “structured data” refers to data organized according to a predefined schema, such as fields, records, or tables, enabling efficient storage, retrieval, and processing by computer programs.

The term “storage device” refers to a non-transitory computer-readable medium, such as a magnetic disk, solid-state memory, or networked storage, that stores data or programs for access by a processor.

The term “client device” refers to a computing device, such as a terminal, mobile device, or workstation, that communicates with the server over an information communication network to receive structured data and present information to a user.

The term “importance” refers to a metric or classification that represents a priority level or urgency of attack plan information, determined based on at least confidence information and impact information.

The term “important attack plan information” refers to attack plan information that has been determined to satisfy at least one predetermined condition related to importance, such as exceeding a threshold of confidence or impact.

The term “notification data” refers to data formatted for use in a notification mechanism, including at least an identifier of important attack plan information and content suitable for display in a user notification.

The term “historical data set” refers to a collection of stored data including past competitor trend data, corresponding actual behavioral results, and past explanation information, used for training or updating a prediction model.

The term “actual behavioral results” refers to data indicating observed real-world actions or events of an external entity that correspond to or validate previously predicted behavioral strategies.

The term “learning process” refers to a computational procedure in which parameters of a prediction model are adjusted based on a historical data set to improve the model's performance on a prediction task.

The term “feedback process” refers to a process in which outputs of the system, including attack plan information and comparison with actual behavioral results, are used to modify at least one of the prediction model and the prompt sentence generation process.

The term “generation process of the prompt sentence” refers to a series of computational operations that construct the content and structure of a prompt sentence based on input data including competitor trend data, attack plan information, and optionally historical performance indicators.

The term “processor” refers to a hardware computing unit or a combination of hardware computing units capable of executing instructions stored in a memory, including, for example, a central processing unit or a processing core within a computing system.

In one embodiment, a server, a terminal, and a user cooperate to implement a system for collecting public information, generating prediction results regarding future behavioral strategies of external entities, and providing structured explanations using a generative AI model.

The server includes at least one processor, a main memory, a non-transitory storage device, and a network interface. The server is implemented, for example, on a general-purpose computing platform running an operating system such as a server-class operating system, and is connected to an information communication network such as the Internet. The storage device stores an information collection program, a natural language processing program, a machine learning program, a generative AI interface program, and a data management program. The server further stores configuration data including target entity identifiers, URL lists, keyword lists, model parameters, and notification thresholds.

The server executes the information collection program to acquire document information as public information on the information communication network. In one example, the server uses a web-crawler framework such as a general-purpose crawling library and an HTTP client library to periodically send HTTP GET requests to a plurality of web servers specified in a configuration file. The server stores, in the storage device, response data including HTML, JSON, and XML documents, together with metadata such as acquisition time, source address, and content type. The server converts each acquired document into a normalized internal representation including at least a text field, a title field, a timestamp field, and a source identifier field. This internal representation is stored, for example, in a relational database management system such as a general-purpose SQL database, in a table for raw document information.

The server executes the natural language processing program on the acquired document information. In one example, the server uses a natural language processing library such as a tokenization and morphological analysis library to segment sentences into tokens and to assign part-of-speech tags. The server then performs term extraction using a statistical method such as term frequency-inverse document frequency and rule-based phrase detection to identify candidate terms representing entities, events, products, and markets. The server removes unnecessary terms by applying a stop-word list and heuristic filters that exclude extremely frequent or extremely rare terms and terms dominated by non-alphabetic characters. The server generates feature vectors representing each document by concatenating statistical features (for example, TF-IDF scores), positional features (for example, term positions in the document), and semantic features (for example, embedding vectors computed by a pre-trained word embedding model or a transformer-based sentence encoder). The server stores the resulting competitor trend data as structured records in a database table, with fields such as entity identifier, event timestamp, extracted terms, and feature vector identifiers.

The server executes the machine learning program based on the competitor trend data. In one embodiment, the server loads a prediction model implemented as a neural network. The neural network includes, for example, an input layer corresponding to the dimension of the feature vectors, one or more hidden layers composed of fully connected units with nonlinear activation functions such as rectified linear units, and an output layer that outputs, for each possible attack plan category, a probability value using a softmax function. The server stores model parameters such as weight matrices and bias values in the storage device. The server normalizes input feature vectors using stored scaling parameters and forwards the normalized vectors through the neural network by performing matrix multiplications and activation operations in the processor. The server obtains, as output, a probability distribution over a finite set of behavioral strategy categories and a scalar value representing predicted impact, which may be computed by a separate regression head of the network or by mapping the categorical prediction to an impact score.

In another embodiment, the server executes a prediction model implemented as an ensemble method, such as gradient boosting or random forest, using decision trees that operate on numerical and categorical features generated from the competitor trend data. The server computes, for each input record, a probability that a specific future behavioral strategy will occur and uses a calibrated probability estimation method to produce confidence information.

The server generates attack plan information by combining the prediction results and associated confidence information and impact information. The server stores this data in a structured format such as a row in a prediction table, including fields for external entity identifier, predicted attack plan category, probability value, impact score, and internal model identifier. The server computes importance by applying comparison operations between the probability value and a threshold, and between the impact score and an impact threshold. The server sets an importance flag when both thresholds are exceeded.

The server generates a prompt sentence for a generative AI model based on the attack plan information and the competitor trend data. The server constructs the prompt sentence according to a predefined template stored in the storage device. In one example, the server generates a prompt sentence such as:
“Based on the following competitor activities: increased research and development hiring in the last 60 days, multiple intellectual property filings in the same technology area, and a public event scheduled for next month, the prediction model has classified the next attack plan as ‘new product launch’ with a probability of 0.87 and a high impact score. As a generative AI model, explain in 3-5 sentences why this attack plan is likely and what specific impact it may have on our organization's market position.”

In another example, the server generates a prompt sentence such as:
“Using the latest competitor trend data from the past 30 days, including press releases, hiring information, and marketing announcements, the prediction model has identified a potential ‘price reduction’ strategy with medium impact. As a generative AI model, provide a concise explanation of the possible causes of this strategy and the likely consequences for our pricing and customer retention.”

The server passes the prompt sentence and optionally a condensed version of the competitor trend data as context to the generative AI model via the generative AI interface program. The server uses, for instance, an application programming interface of a large language model service and sends the prompt sentence as text data, together with model parameters such as temperature and maximum token length. The server receives, from the generative AI model, explanation information in natural language that describes reasons and likely impacts of the predicted attack plan.

The server stores the explanation information together with the corresponding attack plan information as structured data in a prediction-and-explanation table. The server indexes this table using keys such as external entity, time window, and attack plan category. This structuring improves query efficiency and reduces the amount of data that must be transmitted to the terminal. The server transmits a subset of fields, such as the predicted category, probability, impact score, importance flag, and explanation text, to the terminal via a network interface using a communication protocol such as HTTPS.

The terminal includes at least one processor, a memory, a display, an input interface, and a communication module. The terminal executes a client application developed with a cross-platform framework such as a mobile application framework. The terminal receives structured data from the server and caches it in a local storage area. The terminal parses the structured data, converts prediction records into in-memory objects, and organizes them by external entity and time period. The terminal renders a graphical dashboard on the display using visualization components such as chart libraries and list components. The terminal highlights important attack plan information by applying color coding and icon indicators based on the importance flag transmitted by the server.

The terminal receives notification data from the server via a push notification service provided by the operating system. The terminal displays notification messages to the user when important attack plan information is received. The notification message may include text such as “A competitor is likely to launch a new product next month with high impact. Tap to view details.” When the user interacts with the notification, the terminal opens a detailed view showing the underlying competitor trend data, the predicted attack plan, and the explanation text generated by the generative AI model.

The user operates the terminal to review prediction results and explanation information. The user may specify monitoring preferences, such as target external entities and minimum importance thresholds, through configuration screens in the terminal application. The terminal sends updated settings to the server, and the server adjusts its importance determination logic accordingly. The user may further request additional analysis by initiating a custom prompt request. For example, the user may input a prompt sentence such as:
“As a generative AI model, analyze the recent trend data for Entity X and propose three possible future strategies and corresponding countermeasures for our organization.”

The terminal transmits this prompt sentence and selected competitor trend data to the server. The server appends technical context and forwards it to the generative AI model. The server receives an extended explanation or strategy proposal and returns it to the terminal for display.

The server implements a learning process on the prediction model using a historical data set stored in the storage device. The historical data set includes past competitor trend data, corresponding attack plan information generated by the model at earlier times, explanation information from the generative AI model, and actual behavioral results observed later. The server periodically computes an error signal by comparing predicted categories and probabilities with actual observed outcomes. In the case of a neural network model, the server computes a loss function such as a cross-entropy loss for classification, optionally combined with a mean squared error term for impact score prediction. The server computes gradients of the loss function with respect to model parameters using backpropagation and updates the parameters using an optimization algorithm such as stochastic gradient descent or Adam. In this way, the server adapts the internal weight matrices and bias values to minimize prediction error across the historical data set.

The server updates the generation process of the prompt sentence based on the same feedback. For example, the server analyzes which prompt components (such as including explicit probabilities, time ranges, or certain feature descriptions) lead to explanation information that better correlates with actual outcomes, as evaluated by numeric metrics such as explanation relevance scores. The server adjusts template patterns, ordering of information, or inclusion of confidence values in the prompt sentence to improve the quality and consistency of generated explanations. This feedback process results in improved alignment between the structured prediction layer and the generative explanation layer, which constitutes an improvement in computer-based prediction and explanation systems beyond merely automating human text drafting.

The server uses specific data structures and processing flows to achieve technical effects such as reduced communication load and improved computation efficiency. For example, the server generates a compact record structure in which each prediction record stores only identifiers for raw documents and a small number of summary fields, rather than transmitting full document texts to the terminal. The server carries out feature generation and prediction computations centrally on server hardware optimized for high-throughput numerical operations, such as hardware including vectorized instruction sets and optional accelerator units. This design reduces redundant processing on multiple terminal devices, decreases network bandwidth consumption, and achieves faster response times when the terminal requests updated prediction results.

The server further applies non-conventional rules and algorithms tailored to competitor trend analysis, rather than generic text classification. For instance, the server uses temporal aggregation rules that weight recent events more heavily than older events when constructing feature vectors, and uses domain-specific term weighting that increases the importance of terms corresponding to events like job postings, patent filings, or product announcements. These rules are embedded in the feature generation and prediction stages, and they enable the model to detect patterns and anomaly signals that human analysts may not consistently identify. The combination of these specially designed rules with neural network-based or ensemble-based prediction algorithms produces higher prediction accuracy and lower false positive rates compared to generic approaches.

In another embodiment, the server deploys multiple prediction models, such as a fast, lightweight model and a more complex deep neural network model. The server first applies the lightweight model to screen large volumes of competitor trend data and identifies candidate records that potentially correspond to impactful attack plans. The server then applies the complex model only to the candidates, thereby reducing computational load. The server uses a control algorithm that selects which model to apply based on input complexity and current system load, improving throughput and latency. This multi-model orchestration contributes to the improvement of computer technology by optimizing resource usage and enabling near real-time processing of large-scale network data.

The system thus improves computer technology by providing a specialized pipeline that integrates web-scale data acquisition, structured feature generation, predictive modeling, and generative-language-based explanation, all under an adaptive feedback loop. The server modifies internal model parameters and prompt templates based on actual outcomes and evaluation metrics, leading to quantifiable improvements in prediction accuracy, explanation relevance, and system responsiveness. The terminal benefits from reduced data volume and preprocessed structured information, thereby lowering processing burden and power consumption on resource-constrained devices. The user receives technically enhanced outputs—predictions and explanations that are computed using non-trivial algorithms and specialized data structures—rather than mere automation of manual reporting.

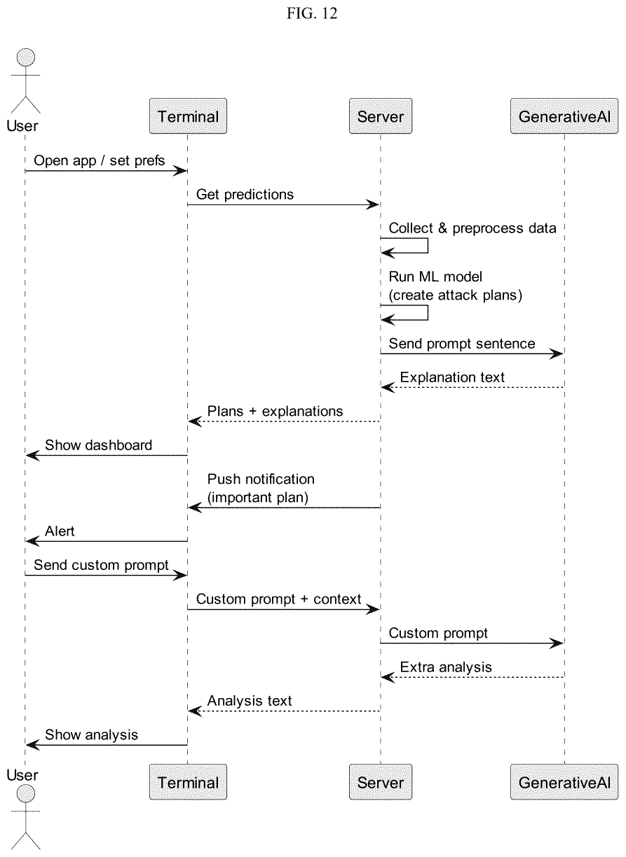

The following describes the processing flow using FIG. 12.

### Step 1

Server initializes system configuration and resources.

Server receives, as input, configuration data including target entity identifiers, URL lists, keyword lists, crawl intervals, model identifiers, and notification thresholds stored in a configuration file or database.

Server loads this configuration data into memory and validates formats (for example, checking that URLs are syntactically valid and that thresholds are within allowable ranges).

Server establishes connections to a storage device, such as a relational database, by opening database sessions and preparing SQL statements.

Server loads model parameters for a prediction model and parameters for a generative AI model interface (for example, API endpoint, authentication token, maximum token length) into internal data structures.

Server outputs an initialized runtime environment including in-memory configuration objects, open database connections, and ready-to-use model descriptors, which are used as inputs in subsequent steps.

### Step 2

Server collects document information as public information from an information communication network.

Server receives, as input, the list of target URLs, crawl intervals, and optional keyword filters from the configuration loaded in Step 1.

Server sends HTTP GET requests to each target URL using an HTTP client module and receives response messages including HTML, JSON, or XML documents.

Server parses each response to extract the main content, title, timestamp (for example, from HTTP headers or meta tags), and source identifier.

Server normalizes character encoding to a unified format and removes non-content elements such as navigation menus or advertisements using pattern-based filters.

Server outputs normalized document records, each including at least a text body, title, timestamp, and source identifier, and inserts these records into a raw document table in the storage device.

### Step 3

Server preprocesses document information using a natural language processing program.

Server receives, as input, raw document records retrieved from the raw document table that have not yet been processed, identified by a processing status flag.

Server performs tokenization by splitting text into tokens based on language-specific rules, then applies morphological analysis to assign part-of-speech tags and base forms to each token.

Server extracts terms by computing term frequency-inverse document frequency values over a sliding time window and by applying phrase-detection rules to recognize multi-word expressions.

Server removes unnecessary terms by filtering out tokens found in a stop-list, tokens with extremely low TF-IDF, and tokens that match noise patterns such as sequences of punctuation characters.

Server generates feature vectors by mapping each remaining term to a numeric index and building a sparse vector or dense embedding representation; the server may apply dimensionality reduction to improve computational efficiency.

Server outputs competitor trend data records, each including an external entity identifier, a list of extracted terms, and one or more feature vectors, and stores these records in a trend data table in the storage device.

### Step 4

Server constructs input sequences for the prediction model.

Server receives, as input, competitor trend data records from the trend data table corresponding to a given time window for each external entity.

Server aggregates multiple events for the same external entity by sorting them in chronological order and concatenating their feature vectors into a sequence representation, optionally applying time-decay weights to older events.

Server pads or truncates sequences to a fixed length required by the prediction model, and normalizes feature values using precomputed scaling parameters.

Server organizes the processed sequences into a batch matrix suitable for vectorized computation, with each row representing one external entity's trend sequence.

Server outputs a batch of normalized, fixed-length input sequences that are directly consumable by the prediction model.

### Step 5

Server executes the prediction model to generate attack plan information.

Server receives, as input, the batch of normalized input sequences constructed in Step 4.

Server forwards each input sequence through the prediction model, which may be a neural network composed of one or more hidden layers, or an ensemble model such as gradient boosting.

Server computes, inside the model, activation values by performing matrix multiplications with stored weight matrices, applying nonlinear activation functions, and aggregating intermediate outputs.

Server obtains, at the output layer, a probability distribution over predefined attack plan categories and optionally a separate predicted impact score.

Server creates attack plan information records including external entity identifier, predicted category, probability value, impact score, and model identifier.

Server outputs these attack plan information records and stores them in an attack plan table in the storage device.

### Step 6

Server determines importance of attack plan information.

Server receives, as input, attack plan information records from the attack plan table that do not yet have an importance flag.

Server compares the probability value of each record with a probability threshold and compares the impact score with an impact threshold defined in the configuration.

Server applies logical conditions such as “probability≥threshold1 AND impact≥threshold2” to decide whether a record is important.

Server sets an importance flag and calculates an importance level (for example, high, medium, low) based on the degree by which the values exceed threshold values.

Server outputs updated attack plan information records containing importance flags and levels and writes them back to the attack plan table.

### Step 7

Server generates a prompt sentence for a generative AI model.

Server receives, as input, attack plan information records and corresponding competitor trend data records for which explanation information has not yet been generated.

Server selects, from trend data, a subset of key terms and events associated with each attack plan, such as major extracted terms and the most recent events with high relevance scores.

Server inserts these terms and the predicted attack plan category, probability, and impact values into a predefined textual template to form a prompt sentence.

Server may, for example, generate a prompt sentence such as: “Based on the following competitor activities: [activity summary], the prediction model classified the next attack plan as [category] with probability [p] and impact score [s]. As a generative AI model, explain in 3-5 sentences why this attack plan is likely and what impact it may have on our organization.”

Server outputs a prompt sentence string for each attack plan information record and stores a link between the record and its prompt in a prompt log table.

### Step 8

Server obtains explanation information from the generative AI model.

Server receives, as input, prompt sentences from the prompt log table along with model interface parameters such as target model name and maximum token limit.

Server sends each prompt sentence to the generative AI model via a network-based application programming interface, encoding the prompt as text in the request body.

Server waits for and receives, as a response, explanation text generated by the generative AI model, which contains natural language reasoning and impact analysis.

Server validates the response length, checks for transmission errors, and, if necessary, retries or logs error conditions.

Server outputs explanation information records that associate each attack plan information record with the received explanatory text, and stores these records in an explanation table in the storage device.

### Step 9

Server structures and transmits prediction and explanation data to the terminal.

Server receives, as input, requests from the terminal specifying external entities, time ranges, and desired detail levels.

Server queries the attack plan table and explanation table using these parameters and retrieves only selected fields, such as predicted category, probability, impact score, importance flag, and explanation text.

Server aggregates these fields into structured response objects, such as compact records or lists, and serializes them into a format suitable for network transmission, such as a structured text format.

Server sends the serialized data to the terminal over a secure communication channel, thereby minimizing transmitted size by excluding raw document text and redundant data.

Server outputs network responses that contain ready-to-display prediction and explanation data for the terminal.

### Step 10

Terminal receives and stores prediction and explanation data.

Terminal receives, as input, the structured data sent by the server in Step 9 via a communication module.

Terminal parses the received data and converts it into internal data structures such as arrays or objects representing attack plans and associated explanations.

Terminal stores these structures in local memory and optionally persists them in a local storage area to allow offline access.

Terminal indexes the data by external entity and time period to enable efficient retrieval for subsequent display operations.

Terminal outputs an in-memory dataset of predictions and explanations that can be used by visualization and notification components.

### Step 11

Terminal displays prediction and explanation data on a graphical interface.

Terminal receives, as input, the in-memory dataset generated in Step 10 and display configuration settings such as sorting options and filtering criteria.

Terminal groups records by external entity and orders them by time or importance level, then generates view models specifying text labels, numerical values, and visual attributes such as colors and icons.

Terminal renders list items, charts, and detail views on the display, mapping probability and impact values to graphical indicators such as bar lengths or color intensity.

Terminal shows explanation text provided by the generative AI model in association with each attack plan, enabling the user to read reasons and expected impacts directly on the screen.

Terminal outputs a graphical user interface that visually presents the server-generated predictions and explanations to the user.

### Step 12

Terminal processes notification data and presents alerts to the user.

Terminal receives, as input, notification data from the server or from a platform-specific push notification service that indicates important attack plan information.

Terminal examines the importance level and category fields in the notification data and maps them to notification display parameters such as alert style and sound.

Terminal generates a notification message that includes a brief summary, for example “High-impact new product launch predicted for Entity A,” and associates it with a link to the corresponding detail view.

Terminal displays the notification on the user's device; when the user interacts with the notification, the terminal opens the application and navigates to the detailed prediction and explanation screen.

Terminal outputs a user-facing alert mechanism that ensures timely awareness of important attack plans.

### Step 13

User configures monitoring preferences and requests additional analysis.

User receives, as input, visualized prediction and explanation data on the terminal's display along with configurable controls for entity selection and threshold settings.

User adjusts controls such as selecting particular external entities to monitor, setting minimum importance levels, or specifying time windows of interest.

User may also enter a custom prompt sentence into an input field, such as “As a generative AI model, analyze the recent activities of Entity B and propose three possible future strategies and their risks.”

User submits these configurations and custom prompt sentences via the terminal interface.

Terminal outputs updated preference data and optional custom prompt text and transmits them to the server, which uses them to adjust subsequent prediction filters and to generate additional generative AI model requests.

### Step 14

Server updates prediction model and prompt generation process using feedback.

Server receives, as input, a historical data set including past competitor trend data, stored attack plan information, explanation information, and actual behavioral results collected after predictions were made.

Server computes, for each historical record, an error metric that indicates discrepancy between the predicted category and the actual observed behavior, and between the predicted impact score and measured impact.

Server updates prediction model parameters by executing a learning algorithm that minimizes a loss function aggregated over the historical data, adjusting weight matrices and biases in a neural network or adjusting tree structures and weights in an ensemble model.

Server analyzes correlations between prompt sentence structures and quality indicators of explanation information, such as user feedback scores or alignment with actual outcomes, and modifies prompt templates by adding or removing elements (for example, explicit probabilities or time frames).

Server outputs an updated prediction model and revised prompt generation rules stored in the storage device, which are used in subsequent executions of the steps above to improve prediction accuracy and explanation quality.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for competitive analysis and action-plan prediction typically rely on either static rule engines or isolated machine learning components that operate on manually curated datasets. First, such systems generally require human operators to collect and cleanse public information from network resources, to engineer features, and to construct inputs for downstream predictive or generative models. This manual involvement leads to latency, inconsistency in data quality, and significant operational burden, thereby limiting the timeliness and reliability of predictions.

Second, existing architectures that incorporate predictive models and generative models often treat these components as separate, loosely coupled services. A predictive model may output numerical scores or class labels, while a generative model may be driven by generic, manually authored prompts that do not systematically reflect the current state of predictions or the historical behavior patterns underlying those predictions. As a result, the generative model may generate narrative scenarios that are misaligned with quantitative predictions, creating a disconnect between the model outputs and degrading the usefulness of the system for decision support.

Third, known systems frequently lack a unified, computer-implemented feedback mechanism that closes the loop between prediction and observed reality. Many systems do not automatically compare prediction results with actual event data to compute prediction accuracy metrics, nor do they systematically retrain or refine predictive models and data preprocessing pipelines based on such metrics. Consequently, model performance may degrade over time as real-world conditions change, without the system being able to adapt in an automated and data-driven manner.

Fourth, prior approaches tend to present predictive results and generative analyses in separate, non-integrated user interfaces. Numerical predictions may be shown in tables or simple charts, while narrative analyses are delivered as plain text without contextual visualization. This fragmented presentation forces users to manually correlate numerical outputs with narrative explanations, increasing cognitive load and reducing the efficiency with which users can interpret and act upon the information.

Accordingly, there is a need for an improved computer-implemented technique that: (i) automatically acquires and preprocesses public information from communication networks to produce consistent, structured learning datasets; (ii) trains and applies prediction models to generate machine-readable prediction data regarding action plans of other parties; (iii) programmatically constructs prompt sentences for a generative AI model based explicitly on such prediction data and related history information; (iv) integrates the outputs of the predictive and generative components into coherent visualization information; and (v) implements a feedback mechanism that continuously monitors prediction accuracy and automatically updates the underlying datasets and models. Such a technique would improve the functioning of the computer system itself by reducing manual intervention, ensuring consistent data transformations, enabling dynamic model adaptation, and providing a unified, machine-generated interface for quantitative and narrative outputs.

The specific processing by the specific processing unit 290 of the data processing device 12 in Example 2 is realized by the following means.

The present invention provides a server comprising a processor configured to automatically acquire target information by executing an automated acquisition process to collect public information over an information communication network, to convert the target information into structured data, to perform preprocessing including missing-value completion and numerical-value normalization to generate a learning dataset, to train a prediction model based on the learning dataset by using a statistical learning algorithm or a machine learning algorithm to generate a trained prediction model, to input newly acquired information into the trained prediction model to calculate a prediction result regarding an action plan of another party and to generate prediction data representing the prediction result, to construct a prompt sentence for causing a generative AI model to preliminarily predict an attack plan or an action plan based on the prediction data and summary history information used to generate the prediction data, to input the prompt sentence into the generative AI model and to receive an analysis result in natural language obtained from the generative AI model, and to convert the prediction data and the analysis result into visualization data to generate visualization information in a format outputtable to a display device, and further configured to select the public information based on a predetermined search term or classification information at the time of collecting the target information so as to efficiently extract information to be included in the learning dataset, and to calculate an accuracy index of the prediction by comparing the prediction data with actual event data and to execute feedback processing to update the learning dataset and the prediction model based on the accuracy index. This enables an integrated computer-implemented pipeline in which network-based data collection, data preprocessing, prediction model training and inference, generative AI prompt construction and analysis, visualization generation, and accuracy-driven feedback are performed automatically and coherently by the server, thereby improving the operation of the computer system through reduced manual configuration, consistent data transformation, adaptive model refinement, and unified presentation of quantitative and narrative outputs for decision support.

The term “processor” refers to one or more hardware-based information processing units, such as a central processing unit or a processing circuit, configured to execute instructions and perform arithmetic, logical, and control operations.

The term “public information” refers to information that is accessible over a communication network without requiring privileged authentication, including, for example, content available on websites, open data services, and publicly exposed application programming interfaces.

The term “information communication network” refers to any wired or wireless communication infrastructure, including, for example, the Internet, a wide area network, or a local area network, that enables electronic devices to exchange data.

The term “automated acquisition process” refers to a computer-implemented procedure that automatically sends requests over a communication network, receives responses, and stores obtained data, without requiring manual data entry by a human operator.

The term “target information” refers to public information selected or identified for collection and subsequent processing in accordance with predetermined conditions, such as search terms, source identifiers, or filtering rules.

The term “structured data” refers to data organized according to a predefined schema, such as tabular data with defined fields, records, and data types, which can be directly processed by computational algorithms.

The term “preprocessing” refers to a series of computer-executed operations that transform raw or semi-structured data into a format suitable for input to a prediction model, including cleansing, normalization, and feature preparation.

The term “missing-value completion” refers to a computational procedure that detects absent or undefined values in data fields and replaces such values with substitute values determined according to a rule, such as a median, mean, or default indicator.

The term “numerical-value normalization” refers to a computational transformation that maps numerical data into a standardized range or scale, such as a predetermined interval, to improve the stability and performance of subsequent learning algorithms.

The term “learning dataset” refers to a collection of structured data instances, each including one or more input features and optionally one or more target outputs, that is used for training or updating a prediction model.

The term “statistical learning algorithm” refers to a computational method that derives a model from data by estimating statistical relationships between input variables and output variables, such as regression models, classification models, or ensemble methods.

The term “machine learning algorithm” refers to a computational method that automatically adjusts model parameters based on data to improve predictive performance, including, for example, decision tree methods, neural network methods, or probabilistic models.

The term “prediction model” refers to a parametric or non-parametric computational structure that, when provided with input feature values, outputs a prediction related to an action plan or other target variable.

The term “trained prediction model” refers to a prediction model whose internal parameters have been adjusted by applying a statistical learning algorithm or a machine learning algorithm to a learning dataset.

The term “newly acquired information” refers to target information collected after training of a prediction model, which has been processed to be suitable as input for inference by the trained prediction model.

The term “prediction result” refers to an output generated by a trained prediction model in response to input data, including, for example, a predicted category, a numerical score, or a probability distribution relating to an action plan.

The term “prediction data” refers to data that encodes one or more prediction results, together with associated metadata such as timestamps, identifiers, or confidence measures, in a machine-readable form.

The term “action plan” refers to a pattern or strategy of behavior expected to be taken by an entity, such as another party, in response to a given situation, including, for example, pricing actions, feature changes, or communication campaigns.

The term “attack plan” refers to a specific type of action plan that is directed toward competitive or adversarial behavior, such as launching a competing offering, adjusting terms, or initiating targeted campaigns.

The term “summary history information” refers to data that represents an aggregated or compressed description of past events, behaviors, or model inputs and outputs, which is used to provide contextual information for generating a prompt sentence.

The term “prompt sentence” refers to a sequence of text or equivalent tokenized content that encodes instructions, context, and constraints to be provided as input to a generative AI model in order to elicit a desired output.

The term “generative AI model” refers to a software-implemented information processing model, such as a language model, configured to generate new data, including natural language text, based on a received prompt sentence and internal parameters.

The term “analysis result” refers to content generated by a generative AI model in response to a prompt sentence, including, for example, narrative explanations, scenario descriptions, or recommendations expressed in natural language.

The term “visualization data” refers to data structures that define visual representations of information, including coordinates, labels, styles, and layout parameters, suitable for rendering by a display system.

The term “visualization information” refers to data or instructions that, when processed by a display device or rendering software, produce a human-perceivable visual output representing prediction data and analysis results.

The term “display device” refers to an output apparatus capable of presenting visual information to a user, such as a monitor, a touch panel, or a projector, often controlled by a client terminal or a server.

The term “search term” refers to a textual or symbolic expression used as a criterion for selecting or filtering public information during the automated acquisition process.

The term “classification information” refers to category identifiers, labels, or attributes associated with public information, used to filter, group, or prioritize data during collection and preprocessing.

The term “actual event data” refers to data representing real-world occurrences that can be compared with prediction data, including recorded actions, observed behaviors, or logged events of an entity.

The term “accuracy index” refers to a quantitative measure that indicates how closely prediction data matches actual event data, such as an error rate, a precision measure, a recall measure, or a composite performance metric.

The term “feedback processing” refers to a set of computer-executed operations that modify a learning dataset, a prediction model, or preprocessing parameters based on an accuracy index or other performance indicators, so as to improve future predictions.

In one embodiment, a server implements the claimed system as a network-connected computing apparatus that includes at least one processor, a memory subsystem, a non-volatile storage device, and a network interface. The server executes an operating system, such as a general-purpose server operating system, and one or more application programs implemented, for example, in a high-level language such as Python. The server cooperates with one or more terminals operated by a user. The terminal includes a display device and an input device, such as a keyboard, a pointing device, and a touch panel, and executes a web browser or a dedicated client application. The server communicates with the terminal over an information communication network.

The server uses a combination of software components to implement the automated acquisition and processing of public information. In one embodiment, the server uses a web crawling framework corresponding to an open-source scraping framework (for example, a framework similar to Scrapy) to transmit Hypertext Transfer Protocol requests through the network interface and to receive Hypertext Markup Language or JavaScript Object Notation responses from web servers. The server uses a markup parsing component corresponding to a document object model parser (for example, a parser similar to BeautifulSoup or a built-in selector engine) to extract text segments, attribute values, and structured fragments from the responses.

The server stores the acquired raw responses as files in the non-volatile storage device and additionally inserts parsed records into a staging table in a relational database management system, such as a general-purpose relational database. Each record in the staging table includes, as fields, a source identifier, a document type, a document timestamp, an extracted title, a body text, and one or more metadata fields such as a category, a region, and an entity name. By imposing such a normalized schema, the server enables efficient indexing and retrieval, which improves data access latency and memory usage compared to ad-hoc, unstructured storage.

The server converts the stored raw and semi-structured data into structured data using a numerical analysis library corresponding to a data frame library (for example, a library similar to Pandas) and a numerical computation library (for example, a library similar to NumPy). The server reads records from the staging table into an in-memory data frame, converts date strings into machine-readable date-time types, converts numerical strings, such as prices or counts, into floating-point or integer representations, and encodes categorical variables using categorical indices or one-hot encodings. The server computes descriptive statistics for each numerical field and determines missing-value locations by identifying null markers.

The server performs missing-value completion by replacing absent numerical entries with a representative statistic, such as a median value of the corresponding column, and optionally creates additional binary indicator columns that mark where imputation occurred. This design allows downstream prediction models to treat the presence of missingness as an explicit feature, which can improve predictive accuracy compared to naive deletion of incomplete records. The server performs numerical-value normalization by applying a scaling transformation implemented using a preprocessing library such as a scaling module comparable to scikit-learn's MinMax scaler. The server fits the scaler to the training portion of the data and persists the scaling parameters to the storage device. By applying a consistent normalization transformation during both training and inference, the server reduces numerical instability and facilitates faster convergence of learning algorithms, thereby improving computational efficiency and model robustness.

The server partitions the preprocessed structured data into a learning dataset that includes input features and corresponding target labels indicative of action plans or attack plans of another party. In one embodiment, the server uses a machine learning library comparable to scikit-learn to perform a stratified split of the data into training and validation subsets. The features can include, for example, temporal features (encoded release dates and intervals), quantitative features (pricing levels, marketing intensity scores), and categorical features (product category, campaign type) that have been mapped into numerical vectors. The labels can specify an action class such as a price reduction, a feature enhancement campaign, a communication-only response, or a combined behavior.

The server trains a prediction model using either a statistical learning algorithm or a machine learning algorithm. In one embodiment, the server trains an ensemble-based model corresponding to a random forest classifier. The server constructs multiple decision trees, each trained on a bootstrap sample of the learning dataset, and at each split node the server randomly selects a subset of features to evaluate. The server computes impurity measures, such as Gini impurity or information gain, to determine split criteria and grows trees until a maximum depth or a minimum sample size is reached. By aggregating the outputs of multiple decorrelated decision trees, the server obtains a prediction model that reduces variance and provides stable probability estimates, which improves accuracy and reduces overfitting relative to a single decision tree.

In another embodiment, the server trains a neural network prediction model using a deep learning framework comparable to TensorFlow or a similar neural network library. The server defines a feed-forward architecture including an input layer whose dimension matches the feature vector length, one or more hidden layers with rectified linear unit or other activation functions, and an output layer with a softmax activation for multi-class classification. The server initializes network weights using a predetermined distribution, such as a uniform or normal distribution tailored to layer size, and defines a loss function such as categorical cross-entropy. The server uses an optimization algorithm such as an adaptive gradient-based optimizer to update weights. For each mini-batch of training samples, the server computes forward activations, evaluates the loss, computes gradients through backpropagation, and applies weight updates. The server monitors validation loss and accuracy, and may apply early stopping when improvement saturates. This architecture and training procedure allow the server to learn non-linear relationships between features and action-plan labels, resulting in improved predictive capability compared to linear or rule-based methods.

The server stores the trained prediction model as a serialized artifact on the non-volatile storage device and registers metadata such as training time, hyperparameters, and validation metrics in a model registry table in the database. After training, the server receives newly acquired information through the same acquisition pipeline, applies the previously determined preprocessing operations, including the stored normalization parameters and imputation rules, and constructs feature vectors consistent with the training phase. The server inputs each feature vector into the trained prediction model to obtain a prediction result, such as a probability distribution over possible action plans. The server aggregates these outputs into prediction data records that include predicted classes, probability values, feature importance vectors, and references to the underlying input events.

The server maintains summary history information derived from past events and prediction results. This summary history information includes, for example, aggregated frequencies of certain action types under specified conditions, conditional probabilities of responses following particular triggers, and long-term trends in behavior. The server stores these summary statistics in a separate table with fields such as an entity identifier, a context descriptor, and numerical summary parameters. By compressing historical behavior into such summaries, the server can efficiently provide high-level context to downstream generative processing without retrieving and transmitting full historical datasets, which reduces communication overhead and memory usage.

The server programmatically constructs a prompt sentence to be input to a generative AI model. In one embodiment, the generative AI model is a large-scale language model accessible via an application programming interface. The server composes the prompt sentence by concatenating fixed instruction templates with dynamic segments that encode prediction data and summary history information. For example, the server may generate a prompt sentence such as: “You are a competitive strategy analyst. Based on the following historical reaction data of competitors and the latest prediction results from our machine-learning model, analyze and describe the most likely competitive attack plans. Historical patterns indicate that a competitor reacts to our mid-range product launches with price cuts in 70% of cases and feature-enhancement campaigns in 20% of cases. Our current predictive model outputs the following probabilities for the upcoming launch: price cut 65%, feature-based differentiation 25%, PR-only response 10%. Considering this context, generate three detailed attack scenarios for the competitor over the next three months, and recommend corresponding defensive strategies focusing on pricing, feature roadmap, and communication timing.”

The server ensures that the prompt sentence embeds structured numerical outputs (for example, probabilities and frequencies) in a textual format that the generative AI model can interpret. This procedure tightly couples the predictive and generative components, ensuring that narrative outputs are grounded in computed prediction data rather than arbitrary or generic text. The server transmits the prompt sentence to the generative AI model via a network call, including configuration parameters such as maximum output length and generation temperature, and receives an analysis result expressed in natural language. The server may optionally post-process the analysis result by segmenting it into paragraphs, headings, or bullet lists for improved readability on the terminal.

The server converts the prediction data and the analysis result into visualization data. The server generates data structures such as arrays of coordinates, labels, and style parameters. In one embodiment, the server formats these structures as JavaScript Object Notation responses suitable for a browser-based plotting library comparable to Plotly or as vector graphics instructions suitable for a server-side plotting library comparable to Matplotlib. The server includes both quantitative charts, such as bar graphs of predicted probabilities and timeline plots of expected response intensity, and textual overlays summarizing the generative analysis. By integrating numerical and narrative content into a single visualization information object, the server reduces the need for the user to reconcile disparate sources of information manually, thereby improving decision-making efficiency.

The terminal receives visualization information from the server and renders it on the display device. The terminal executes plotting scripts or rendering instructions and presents interactive charts where the user can select different competitors, time ranges, or action-plan categories. The terminal may also display the analysis result from the generative AI model in a panel adjacent to the charts. The user can use input controls on the terminal to request alternative scenarios, refine the scope (for example, a particular geographic region or product category), or adjust assumptions. The terminal transmits these user selections back to the server, which may cause the server to recompute prediction data, to reconstruct a new prompt sentence, and to obtain a revised analysis result from the generative AI model.

The server implements a feedback processing mechanism to improve the accuracy of predictions over time. The server periodically or conditionally retrieves actual event data from the database, representing real-world outcomes such as observed price changes, product launches, or communication campaigns. The server aligns this actual event data with prior prediction data based on identifiers and timestamps, and computes an accuracy index using metrics such as precision, recall, F1 score, or cross-entropy. The server stores these performance metrics and, when degradation beyond a threshold is detected or when sufficient new data is accumulated, the server initiates retraining. During retraining, the server updates the learning dataset to include both historical and newly observed events, recomputes preprocessing statistics (such as medians and scaling ranges) or retains them according to a defined policy, and retrains the prediction model using the updated dataset. This feedback loop enables the server to adapt model parameters and preprocessing logic to changing patterns, which reduces prediction error and maintains performance in dynamic environments.

The described architecture provides technical improvements over conventional manual or loosely coupled systems. By automatically enforcing consistent preprocessing, normalization, and feature representation, the server reduces computational overhead associated with ad-hoc data preparation and decreases the risk of numerical instability in model training. By using ensemble decision structures or neural networks with explicit architecture and optimization procedures, the server achieves improved prediction accuracy and convergence speed relative to simple rule-based schemes. By programmatically binding prediction data and history summaries into prompt sentences, the server restricts the input domain to the generative AI model, reducing unnecessary token usage and network payload, which in turn reduces communication load and processing time on the external model infrastructure. By integrating predictive and generative outputs into unified visualization data and by managing a continuous feedback pipeline, the server enhances the internal operation of the computer system, resulting in faster, more accurate, and more resource-efficient processing that is not a mere automation of human judgment but a technical enhancement of computational workflows.

In alternative embodiments, the server can use different predictive model types, such as gradient-boosted decision trees, support vector machines, or probabilistic graphical models, as long as the server produces prediction data that quantifies action-plan likelihoods. The server can also employ different neural network architectures, such as recurrent networks or transformer-based encoders, when temporal sequences are to be modeled explicitly. The generative AI model can be hosted locally on the server or accessed as a cloud-based service; in either case, the server continues to construct prompt sentences based on structured prediction data and summary history information and to process returned natural language analysis results. The terminal can be implemented as a desktop computer, a mobile device, or an embedded terminal, provided that it is capable of displaying visualization information and sending user inputs to the server.

Through these configurations and variations, the server, the terminal, and the user cooperate in a system that automatically acquires, structures, and analyzes public information, generates technically grounded prediction data and narrative analyses via a generative AI model, and continuously refines its internal models based on feedback, thereby realizing an implementation of the invention that can be practiced by those skilled in the art.

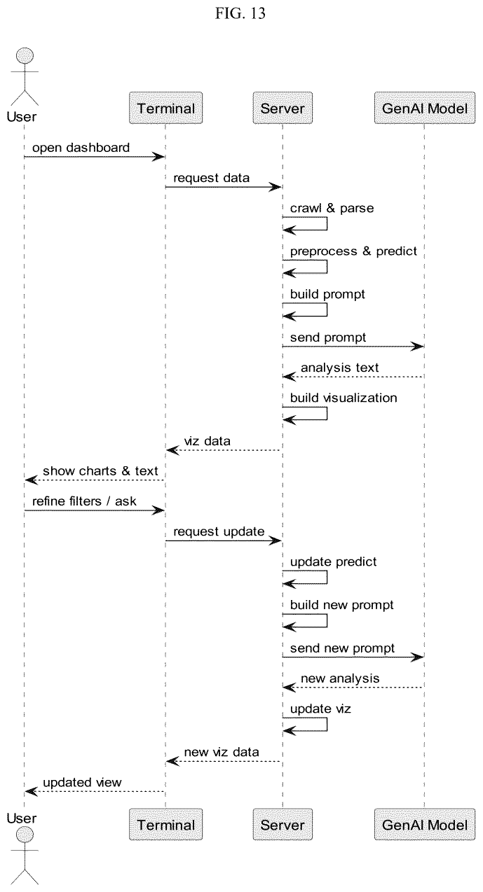

The following describes the processing flow using FIG. 13.

### Step 1

The server reads a configuration file stored in a storage device and obtains, as input, a list of target network resources, such as uniform resource locators, search terms, and category filters. The server uses this input to initialize a web-crawling module and a network communication module. Based on the listed network resources and filters, the server sends structured Hypertext Transfer Protocol requests over an information communication network, receives response messages such as Hypertext Markup Language documents or JavaScript Object Notation payloads, and writes the raw response bodies and associated metadata into a staging storage area in a database. As a result, the server outputs a collection of raw public information records, each record including at least a source identifier, a retrieval timestamp, a document type, and a content field.

### Step 2

The server loads, as input, the raw public information records from the staging storage area and instantiates a parsing and extraction module. The server applies document object model parsing and pattern matching to each record, extracts structured elements such as titles, timestamps, entity names, numerical values, and descriptive text segments, and maps them into intermediate key-value structures. The server then converts the extracted key-value structures into a tabular representation implemented as an in-memory data frame. During this conversion, the server assigns explicit data types to each column. The server outputs a structured dataset in which each row corresponds to an event and each column corresponds to a specific attribute ready for subsequent preprocessing.

### Step 3

The server receives, as input, the structured dataset generated in Step 2. The server scans each column to detect missing entries and invalid values and computes descriptive statistics such as minimum, maximum, mean, and median for numerical columns. Using these statistics, the server performs missing-value completion by replacing null or invalid entries with a median or a predefined default and optionally adds binary indicator columns marking imputed positions. The server then applies numerical-value normalization by transforming each numerical column into a bounded range, for example between zero and one, using a scaling function whose parameters are computed from the current dataset. The server stores the scaling parameters in persistent storage for reuse. The server outputs a preprocessed dataset with completed and normalized values and with explicit indicators of imputation locations.

### Step 4

The server treats the preprocessed dataset from Step 3 as input and separates it into two components: a feature matrix containing explanatory variables and a label vector containing target variables that represent action-plan categories or related outcomes. The server uses a data-partitioning module to split these components into training and validation subsets according to a specified ratio, while optionally preserving the distribution of labels. During this process, the server also records the index mapping between original records and split subsets. The server outputs a training feature matrix and label vector, a validation feature matrix and label vector, and associated split metadata describing the partitioning.

### Step 5

The server takes, as input, the training feature matrix and label vector, as well as configuration parameters specifying a model type and hyperparameters. When an ensemble decision-tree model is selected, the server constructs multiple decision trees by sampling the training data with replacement and by randomly selecting subsets of features at each split. For each candidate split, the server computes an impurity measure, selects the split that maximizes impurity reduction, and grows the tree until stopping conditions are met. The server aggregates the outputs of all trees to form a prediction model. When a neural network model is selected, the server defines an architecture with an input layer, hidden layers, and an output layer, initializes weights, and iteratively updates them by computing forward passes, evaluating a loss function, computing gradients by backpropagation, and applying an optimization rule. The server evaluates the trained model on the validation data, computes metrics such as accuracy and loss, and records these metrics. The server outputs a trained prediction model object and associated performance information.

### Step 6

The server receives, as input, newly acquired public information records that have passed through Steps 1 and 2, as well as the stored normalization parameters and imputation rules. The server applies the same missing-value completion and normalization operations as in Step 3 to these new records, thereby generating feature vectors compatible with the trained prediction model from Step 5. The server inputs the feature vectors into the trained prediction model and computes, for each new event, a prediction result such as a class label and a probability distribution over possible action-plan categories. The server combines these prediction results with identifiers and timestamps and outputs a set of prediction data records representing the predicted behavior of other parties.

### Step 7

The server uses, as input, the prediction data from Step 6 and historical event data stored in a database. The server aggregates and summarizes the historical event data to generate summary history information, such as frequencies of past action types under similar conditions and temporal patterns of responses. The server computes statistical summaries, for example conditional probabilities and moving averages, and stores them as compact numerical descriptors associated with specific entities and contexts. The server outputs a summary history dataset that can be referenced together with the prediction data to provide context for further analysis.

### Step 8

The server receives, as input, the prediction data from Step 6, the summary history dataset from Step 7, and predefined textual templates for constructing a prompt sentence. The server converts selected numerical values, such as predicted probabilities and historical frequencies, into textual descriptions and inserts them into the templates in predetermined positions. The server concatenates instruction text, contextual descriptions, and these numerical descriptions to form a coherent prompt sentence that instructs a generative AI model to analyze likely attack plans or action plans. For example, the server may generate the following prompt sentence as output:
“You are a competitive strategy analyst. Based on the following historical reaction data of competitors and the latest prediction results from our machine-learning model, analyze and describe the most likely competitive attack plans. Historical patterns indicate that a competitor reacts to our mid-range product launches with price cuts in 70% of cases and feature-enhancement campaigns in 20% of cases. Our current predictive model outputs the following probabilities for the upcoming launch: price cut 65%, feature-based differentiation 25%, PR-only response 10%. Considering this context, generate three detailed attack scenarios for the competitor over the next three months, and recommend corresponding defensive strategies focusing on pricing, feature roadmap, and communication timing.”

### Step 9

The server uses, as input, the prompt sentence created in Step 8 and communication parameters for accessing an external or internal generative AI model. The server establishes a network connection to a generative AI model service, transmits a request message containing the prompt sentence and generation settings, and waits for a response. The generative AI model returns an analysis result in natural language, containing narrative descriptions and recommendations. The server receives this result and, if necessary, segments it into list items or sections according to punctuation and keywords. The server outputs a processed analysis result text that can be associated with the underlying prediction data and identifiers.

### Step 10

The server takes, as input, the prediction data from Step 6 and the processed analysis result from Step 9. The server constructs visualization data structures such as arrays for axes values, series labels, probability values, and layout parameters. The server generates chart specifications for bar graphs, line graphs, and tables that depict predicted probabilities, time horizons, and confidence levels, and associates these with textual overlays extracted from the analysis result. The server formats this combined visualization data as a response payload suitable for rendering on a terminal, for example in a structured data format that includes both graphical and textual elements. The server outputs visualization information that encapsulates the prediction results and narrative analysis in a single, coherent structure.

### Step 11

The terminal receives, as input, the visualization information provided by the server in Step 10 via a network response. The terminal parses the received data, instantiates graphical components, and renders charts and text in a graphical user interface on a display device. The terminal maps numerical arrays to visual objects such as bars, lines, and markers, applies styles and labels, and places narrative text in designated areas of the screen. The terminal outputs an interactive visual presentation that allows the user to observe predicted action plans and corresponding analytical explanations.

### Step 12

The user views, as input, the interactive visual presentation on the terminal display. Based on the displayed charts and narrative text, the user operates input devices to adjust filters, such as selecting a particular entity, region, or time period, or to request refined scenarios. The terminal transmits these user selections and instructions back to the server as request parameters. The server interprets the received parameters as new input to Steps 6 through 10, recalculates prediction data if necessary, reconstructs a new prompt sentence reflecting the updated context, obtains a new analysis result from the generative AI model, and regenerates visualization information. The terminal then updates the display, and the system thus outputs refined visual and textual content tailored to the user's current selection.

### Step 13

The server receives, as input, archived prediction data and subsequently collected actual event data representing real-world outcomes. The server aligns prediction records with corresponding actual events based on identifiers and timestamps and computes an accuracy index using predefined metrics. The server stores these accuracy indices and evaluates whether performance thresholds are met. When thresholds are not met or a retraining condition is satisfied, the server uses the accumulated actual event data to update the learning dataset, recomputes or confirms preprocessing parameters, and retrains the prediction model as in Step 5. The server outputs an updated trained prediction model and updated performance metrics, which are then used in subsequent executions of Steps 6 through 10 to provide improved prediction accuracy and reduced error.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented analysis systems that monitor external entities, such as competitors in a market, generally rely on static rule-based processing pipelines. These systems typically collect public information, apply simple filtering or keyword matching, and then output dashboards or reports. However, such systems suffer from multiple technical limitations.

First, existing data collection and preprocessing pipelines are not tightly integrated with predictive models and generative artificial intelligence models in a feedback-controlled manner. Raw document data is often transformed into fixed reports without leveraging structured feature information to dynamically train and update prediction models of external action plans. As a result, the systems are unable to efficiently utilize computing resources to infer likely future behaviors and associated risks at high temporal resolution.

Second, known systems generally treat generative artificial intelligence models as isolated components that only receive manually written prompts. There is no systematic computer-implemented mechanism for automatically constructing prompt sentences based on machine-learned predictions, structured context, and user state, and for feeding these prompts into a generative artificial intelligence model in a closed-loop architecture. Consequently, the generative artificial intelligence model cannot be fully exploited as a computational engine for structured scenario generation, risk explanation, and countermeasure proposal.

Third, existing visualization pipelines often generate static charts or dashboards that do not reflect the internal structure of learned models, such as occurrence probabilities, impact levels, and timing of inferred action plans. The data transformation from model outputs to visualization is typically ad hoc, which leads to information loss, reduced interpretability, and inefficient use of memory and processing bandwidth on both servers and terminal devices.

Fourth, user interaction is usually modeled as a passive consumption of reports, ignoring the user's cognitive and emotional state. Traditional systems do not integrate multimodal sensing (audio and video), machine-learned emotion classification, and prompt generation for the generative artificial intelligence model into a unified processing flow. As a result, the same type of explanation and level of technical detail is delivered to all users regardless of their current emotional state, which can overload users in high-stress situations or under-inform users requiring more detailed technical guidance. This mismatch can increase the amount of computationally wasted interaction cycles, cause repeated queries, and lead to inefficient utilization of network and processing resources.

Accordingly, there is a need for an improved computer-implemented system that (i) automatically collects and preprocesses public information into feature information; (ii) trains and applies prediction models of external action plans; (iii) constructs and inputs structured, context-aware prompt sentences to a generative artificial intelligence model; (iv) converts generated narrative results into structured, visualization-ready data; and (v) estimates a user's emotional state from multimodal signals and dynamically adapts both the prompts and the generative responses. Such a system should improve the technical functioning of the computing environment by reducing redundant processing, enabling more efficient model invocation and visualization, and tailoring information delivery in real time according to inferred user state.

The specific processing by the specific processing unit 290 of the data processing device 12 in Application Example 2 is realized by the following means.

The present invention provides a server comprising a processor configured to execute a crawling acquisition unit that accesses multiple information sources over an information network and acquires document data as public information, a preprocessing unit that applies natural language processing and statistical processing to the document data to convert the document data into feature information including normalized tokens and numerical feature vectors, a learning and prediction unit that uses the feature information together with past outcome information to train a prediction model of action plans of external entities and to estimate current and future action plans and associated risk evaluations, a prompt generation and input unit that, based on the estimated action plans and the risk evaluations, automatically constructs a context-aware instruction sentence as a prompt sentence to a generative artificial intelligence model and inputs the prompt sentence into the generative artificial intelligence model, a result structuring unit that converts explanation sentences and proposal contents output from the generative artificial intelligence model into structured data and associates the structured data with temporal information and entity-related information, a display data generation unit that generates visualization data indicating occurrence probabilities, impact levels, and timing of the action plans based on the structured data and transmits the visualization data to a terminal device, and an emotion estimation and feedback unit that receives voice information and image information from the terminal device, estimates an emotional state of a user by applying an emotion classification model to audio features and facial features, and feeds back emotional-state information as context information to the prompt generation and input unit so as to dynamically adjust contents and response style of subsequent prompt sentences and responses of the generative artificial intelligence model. This enables the computing system to implement an integrated, closed-loop processing architecture in which public information is automatically transformed into feature information, prediction models are trained and applied to infer external action plans, generative artificial intelligence models are invoked with machine-generated prompt sentences that reflect both model outputs and user emotional state, and visualization data is produced in a structured, adaptive manner, thereby improving computational efficiency, responsiveness, and relevance of information delivery within the computer system.

The term “information network” refers to a communication infrastructure that enables electronic devices to exchange digital data, including but not limited to wide-area networks, local-area networks, and packet-switched networks.

The term “public information” refers to electronic data that is accessible without authentication or special authorization via the information network, including documents such as web pages, news articles, reports, and similar content.

The term “information source” refers to any logical or physical endpoint from which public information can be acquired, including network addresses, data services, and repositories.

The term “document data” refers to digital representations of content obtained from information sources, including text data, markup data, and structured or semi-structured records.

The term “crawling acquisition unit” refers to a functional component executed by the processor that automatically accesses multiple information sources according to predefined rules or schedules to acquire document data.

The term “preprocessing unit” refers to a functional component executed by the processor that transforms raw document data into a normalized representation using computational operations such as parsing, cleaning, tokenizing, and feature extraction.

The term “natural language processing” refers to a class of computational techniques that analyze and transform human language data, including operations such as tokenization, part-of-speech tagging, syntactic parsing, and semantic analysis.

The term “statistical processing” refers to computational operations that analyze numerical properties of data, including aggregation, normalization, distribution analysis, and similar techniques applied to derive feature values.

The term “feature information” refers to data structures that represent properties of document data in a machine-processable form, including but not limited to token sequences, numerical vectors, and metadata fields.

The term “tokenization” refers to a processing operation that segments text into smaller units such as words, subwords, or sentences for subsequent analysis.

The term “normalization” refers to a processing operation that transforms data into a standard form, including operations such as case conversion, removal of extraneous symbols, and unification of equivalent terms.

The term “numerical feature vector” refers to an ordered list of numerical values that encodes characteristics of document data or other input signals for use by a computational model.

The term “external entity” refers to an actor or object that exists outside the system and whose behavior is analyzed by the system, such as an organization, a group, or a functional unit.

The term “action plan” refers to a predicted or inferred sequence of actions or strategies that an external entity is likely to perform within a specified time frame.

The term “past outcome information” refers to data describing events or results that have previously occurred in association with external entities, such as executed actions, observed changes, or realized conditions.

The term “learning and prediction unit” refers to a functional component executed by the processor that trains one or more computational models using feature information and past outcome information, and that applies the trained models to estimate action plans and associated metrics.

The term “prediction model” refers to a computational model that receives feature information as input and outputs estimated labels, probabilities, or continuous values representing likely future action plans or related quantities.

The term “risk evaluation” refers to a quantified assessment of potential negative or positive impact associated with a predicted action plan, including measures such as probability, severity, and expected loss or gain.

The term “generative artificial intelligence model” refers to a computational model that produces new data or content, such as text or structured information, in response to an input, including but not limited to models based on machine learning or statistical generation.

The term “prompt sentence” refers to a sequence of natural language or structured tokens that instructs a generative artificial intelligence model to perform a specified task or produce a particular type of output.

The term “prompt generation and input unit” refers to a functional component executed by the processor that constructs prompt sentences based on context information and model outputs, and that provides the prompt sentences as input to a generative artificial intelligence model.

The term “instruction sentence” refers to a type of prompt sentence that explicitly describes to the generative artificial intelligence model what analysis to perform, how to format an output, or which constraints to apply.

The term “result structuring unit” refers to a functional component executed by the processor that converts raw outputs from a generative artificial intelligence model into structured data conforming to predefined formats, schemas, or data models.

The term “structured data” refers to information organized according to a predefined schema or model, such as fields, records, or objects with labeled attributes that can be processed programmatically.

The term “temporal information” refers to data describing time aspects associated with events or records, including timestamps, time intervals, and relative or absolute time indicators.

The term “entity-related information” refers to data that associates structured data with particular external entities, including identifiers, categories, or attributes of such entities.

The term “display data generation unit” refers to a functional component executed by the processor that converts structured data into visualization data suitable for presentation on a display device.

The term “visualization data” refers to data structures that specify graphical or layout elements, such as coordinates, labels, and styles, for representing information visually, including charts, diagrams, and other graphical depictions.

The term “terminal device” refers to an electronic apparatus that provides input and output interfaces to a user, including display, audio, and sensor capabilities, and that communicates with the server over an information network.

The term “occurrence probability” refers to a numerical value indicating the likelihood that a predicted action plan will be realized within a specified condition or time interval.

The term “impact level” refers to a measure of the magnitude of effect that an action plan is expected to exert on a target system, environment, or entity.

The term “timing” refers to temporal positioning or scheduling information that indicates when an action plan is predicted or expected to occur.

The term “emotion estimation and feedback unit” refers to a functional component executed by the processor that infers a user's emotional state from input signals and provides the inferred emotional state to other components as context information.

The term “voice information” refers to digitized audio data representing sound produced by a user, including speech signals and associated acoustic characteristics.

The term “image information” refers to digitized visual data captured from an imaging device, including single frames, video sequences, and derived representations of a user's appearance.

The term “audio feature” refers to a numerical representation of properties of voice information, such as pitch, energy, spectral distribution, and temporal dynamics.

The term “facial feature” refers to a numerical representation of properties of a user's face extracted from image information, such as positions of characteristic points, shape descriptors, and movement over time.

The term “emotion classification model” refers to a computational model that receives audio features, facial features, or other user-related signals as input and outputs an estimated emotional state label or score.

The term “emotional state” refers to a condition of a user that can be inferred from multimodal signals, such as stress level, calmness, confidence, or anxiety, represented in categorical or continuous form.

The term “context information” refers to data that describe circumstances surrounding a processing operation, including user state, recent interactions, model outputs, or environmental conditions, and that are used to influence subsequent processing.

The term “response style” refers to characteristics of an output generated by a generative artificial intelligence model, such as tone, level of formality, complexity, length, and organization.

The term “time-series graph” refers to a visualization that displays how one or more variables change over time using graphical elements such as lines or bars.

The term “distribution diagram” refers to a visualization that represents the statistical distribution of one or more variables, including histograms, box plots, and similar graphical forms.

The term “hierarchical structure diagram” refers to a visualization that represents relationships among entities or concepts in a layered or tree-like manner.

The term “visualization control” refers to processing operations that determine how visualization data are presented on a terminal device, including selection, filtering, scaling, and interactive updates of graphical elements.

The term “degree of detail” refers to a level of granularity or specificity in explanatory or analytical content provided to a user.

The term “level of technicality” refers to a degree of reliance on specialized terminology, formalism, or domain-specific concepts in a description or explanation.

The term “expression style” refers to linguistic and structural characteristics of a generated text, including sentence structure, vocabulary choice, and rhetorical form.

The term “length of the response” refers to a quantity of content produced by a generative artificial intelligence model, such as number of tokens, sentences, or sections.

The term “structure of the response” refers to an organizational pattern applied to the generated content, including headings, ordered lists, sections, or other segmentation.

The term “tone of the response” refers to an overall communicative attitude conveyed by the content, such as neutral, reassuring, urgent, or formal.

In one embodiment, a server, a terminal, and a user cooperate to implement the claimed system. The server comprises one or more processors, a main memory, a non-volatile storage device, and a network interface coupled via a system bus. The terminal comprises a processing unit, a display device, an audio input unit, an imaging unit, and a communication module. The user interacts with the terminal through input operations, voice, and facial expressions.

The server executes a software stack including an operating system, a web crawling module, a natural language processing module, a feature extraction module, a machine learning module, a generative AI interface module, a structuring and storage module, a visualization data generation module, and an emotion analysis and feedback module. The web crawling module can be implemented using a general-purpose programming language runtime (for example, a Python runtime) and a crawling framework (for example, a scraping framework). The natural language processing module can be implemented using a text processing library such as a tokenization and lemmatization library. The machine learning module can be implemented using a numerical computation library and a neural network library. The generative AI interface module can communicate with an external or internal generative AI model implemented, for example, on a separate acceleration device or cloud service.

The server acquires public information from multiple information sources on an information network. The server executes a crawling acquisition unit that issues HTTP requests through the network interface to network addresses registered in a source list. The server receives document data, such as HTML documents, text feeds, and structured responses, and writes the data into a persistent storage structure such as a relational table or a document-oriented collection. Each record contains at least a source identifier, a timestamp, a raw content field, and a content type field.

The server preprocesses the document data into feature information. The server executes the preprocessing unit to parse the raw content field and remove markup tags, scripts, and navigation content using pattern matching and tree-based HTML parsing. The server then applies a natural language processing pipeline to the remaining textual content. The server performs language detection, sentence boundary detection, tokenization, lowercasing, stopword removal, and morphological normalization such as lemmatization. The server optionally applies term-frequency-inverse-document-frequency (TF-IDF) computation across a batch of documents.

The server converts the preprocessed text into numerical feature vectors suitable for machine learning. The server uses, for example, a word-embedding encoder or a contextual embedding encoder. In one implementation, the server represents each document as a fixed-length vector of dimension d, where each element corresponds to either a TF-IDF weight or an embedding coordinate. The server stores the resulting feature vectors in a feature table linked to the original document identifiers.

The server constructs and trains prediction models for external action plans. The server executes the learning and prediction unit on the stored feature vectors and past outcome information. Past outcome information includes historical labels indicating observed actions by external entities, such as “product launch,” “price change,” or “no significant event,” associated with time windows following each document. The server divides the dataset into training, validation, and test subsets.

The server employs one or more supervised learning algorithms. In one embodiment, the server uses a neural network classifier having an input layer of size d, two or more hidden layers with nonlinear activation functions, and an output layer with softmax activation over action plan categories. The server selects a loss function such as categorical cross-entropy. The server initializes network weights randomly or using a heuristic, and iteratively updates the weights using stochastic gradient descent or a variant thereof, such as Adam optimization. The server calculates gradients via backpropagation, updates the weights on each mini-batch, and monitors validation performance to prevent overfitting. The server optionally uses regularization techniques such as dropout on hidden layers and L2 weight decay.

The server can alternatively use an ensemble method such as a random forest or gradient boosting machine. In such an embodiment, the server constructs multiple decision trees on subsets of the training data and features, and aggregates the outputs by averaging probabilities or majority voting. The server tunes hyperparameters such as the number of trees, maximum depth, and minimum samples per leaf using grid search or randomized search guided by validation accuracy.

The server evaluates the trained prediction model on the test subset to measure metrics such as accuracy, precision, recall, and calibration of probability outputs. The server stores the trained model parameters, including network weights or forest parameters, and an associated model version identifier. When new document data is available, the server loads the current model and applies it to the corresponding feature vectors to generate predicted action plan labels and probability distributions.

The server then calculates risk evaluations based on predictions and additional metadata. The server defines a risk evaluation function that combines the predicted probability of each action plan with an impact score derived from domain-specific parameters stored in a configuration structure. The server computes, for each external entity and predicted action plan, a risk score as a function of probability and impact. The server attaches timestamps representing predicted time windows for potential occurrence. The server writes these predictions and risk evaluations into a prediction table indexed by entity and time.

The server generates prompt sentences for a generative AI model by using the prompt generation and input unit. The server selects a subset of prediction records based on recency and significance thresholds. The server summarizes the selected records into a human-readable context section, listing external entities, predicted action plans, probabilities, risk scores, and time windows. The server then constructs an instruction section that specifies the analytical task and output format to be requested from the generative AI model.

For example, the server constructs a prompt sentence such as:
“Context:
   Entity A: high probability of a new product launch within the next two months, with high impact on our current product line.
   Entity B: moderate probability of a discount campaign within the next quarter, with medium impact.
   Entity C: low probability of a market exit in the current year, with low impact.
Instruction:
Based on the above context, analyze the likely scenarios for the next six months, estimate combined risk levels for each entity, and propose a prioritized list of defensive and offensive strategies. Organize the output into the following sections: ‘Scenario Analysis,’ ‘Risk Assessment,’and ‘Recommended Actions.’”

The server composes the context and instruction into a single prompt sentence, encodes it as a sequence of tokens, and transmits it to the generative AI model via the generative AI interface module. The generative AI model can be a large-scale neural network, for example a transformer architecture comprising multi-head self-attention layers and feedforward layers, pre-trained on a large corpus of text and optionally fine-tuned on domain-specific data.

The server adjusts parameters for the generative AI invocation such as maximum output length, sampling temperature, and top-k or top-p sampling thresholds to balance diversity and determinism. The generative AI model processes the prompt sentence by sequentially predicting tokens conditioned on the prompt and previously generated tokens. The server receives the generated token sequence, decodes it into text, and forwards the result to the result structuring unit.

The server structures the generative output into machine-usable records. The server applies pattern recognition and, where appropriate, lightweight parsing rules to identify sections, headings, bullet lists, and key phrases. The server maps the extracted elements into a structured data model that includes fields such as “scenario_summary,” “risk_description,” “recommended_action,” “target_entity,” and “time_horizon.” The server stores this structured data in a scenario table associated with the relevant prediction records and timestamps.

The server then prepares visualization data. The server executes the display data generation unit to transform prediction and scenario data into visualization data structures. The server uses numerical libraries to aggregate risk scores over different time buckets and categories. The server generates time-series values showing probability or risk evolution, distribution values showing risk distribution across entities or action plan types, and hierarchical relationships between entities, action plans, and recommended actions.

The server encodes these visualization data structures as compact objects specifying axis values, labels, and styling hints. The server transmits the visualization data and the structured scenario summaries to the terminal through an application programming interface using, for example, a compressed data format to reduce communication overhead. By sending structured visualization data instead of raw text or full models, the server reduces bandwidth consumption and offloads rendering work to the terminal.

The terminal receives the visualization data and scenario summaries and renders them on the display device. The terminal uses a user interface library to display interactive charts, such as line charts representing risk over time, bar charts comparing entities, and tree-like diagrams showing the relationship between predicted action plans and recommended responses. The terminal displays the narrative explanation generated by the generative AI model in association with the charts, such that the user can inspect both quantitative and qualitative information.

The user can input additional instructions to refine the analysis. The user enters prompt sentences through a text input field or by voice, which the terminal transcribes into text. For example, the user can input: “Using the latest competitor trend data, predict how Entity A will react if we reduce our prices by 10% next month, and suggest a defensive strategy that minimizes profit loss.”

The terminal sends the user's prompt sentence to the server together with contextual information about the currently displayed entities and time ranges. The server merges the user-specific instruction with the latest prediction and scenario data and constructs an extended prompt sentence for the generative AI model. The generative AI model produces a refined analysis that the server structures and returns to the terminal as previously described.

The terminal also captures voice and facial information from the user using the audio input unit and the imaging unit. The terminal samples audio during user speech and compresses it into time frames. The terminal extracts audio features, such as fundamental frequency, energy, spectral centroid, and speaking rate, using a feature extraction algorithm. The terminal simultaneously captures facial images or a video stream from the imaging unit and applies image processing operations, such as face detection, facial landmark detection, and region-of-interest tracking, to obtain facial features including mouth curvature, eye openness, and eyebrow position.

The terminal or the server executes an emotion classification model on the extracted features. In one embodiment, the server receives the features via the information network and uses a neural network classifier consisting of an input layer for concatenated audio and visual features, one or more hidden layers, and an output layer representing discrete emotional states such as “calm,” “stressed,” “confident,” or “confused.” The server trains this classifier using supervised learning on labeled multimodal emotion datasets. The server uses a loss function such as cross-entropy, optimizes weights via gradient-based methods, and evaluates classification accuracy on a validation set. The trained emotion classification model runs on the server in real time for incoming features.

The server uses the estimated emotional state as context information for prompt construction. For example, when the user's emotional state is classified as “stressed,” the server modifies the instruction portion of the prompt sentence to request a shorter, less technical explanation with concrete immediate steps. An example of such an emotion-aware instruction is:
“The user appears anxious and overloaded. Summarize the predicted action plans in no more than five short bullet points, avoid technical jargon, and provide two concrete steps that can be executed this week.”

By contrast, when the emotional state is “confident,” the server can instruct the generative AI model to include more technical detail, justification of assumptions, and discussion of alternative scenarios.

The server thereby creates an adaptive loop in which the output of an emotion classification model dynamically alters prompt sentences and, consequently, the behavior of the generative AI model. This adaptation leads to more efficient use of computational resources in the client-server architecture. When the user is stressed, the system avoids generating excessively long or complex outputs, which reduces token generation and network transfer, while still delivering relevant information. When the user is ready for in-depth analysis, the system can allocate more computational resources to generate comprehensive explanations without repeated follow-up queries.

The described data flow and modular structure provide technical improvements beyond mere automation of human analysis. The server processes raw public information into structured feature information in a non-conventional manner tailored to prediction and generative use: specific feature vector constructions, dedicated prediction models for action plans, and structured prompt sentence generation. The server reduces redundant work by reusing prediction outputs and structured data as inputs to the generative AI model, instead of recomputing context for each query. The emotion-based adaptation reduces repeated queries and unnecessary long-form generation, thereby decreasing error rates related to user misunderstanding and lowering communication and computation load.

The server can implement further variations. In one variant, the server uses a sequence model that accounts explicitly for temporal ordering of documents, such as a recurrent neural network or a transformer encoder that processes time-stamped sequences of document vectors. The server can augment feature vectors with time intervals between documents and with indicators of previous predicted or observed actions. This configuration can improve temporal prediction accuracy, which in turn improves the relevance of prompt context provided to the generative AI model.

In another variant, the server can store intermediate representations, such as hidden layer activations, in a cache when predicting action plans for high-frequency entities. The server then reuses these activations when similar new documents arrive, decreasing computational time for subsequent predictions. The server can also prioritize updates to the prediction model based on feedback from the user, such as ratings of correctness or usefulness of scenarios, by using online learning methods that adjust model weights incrementally.

The terminal can also implement different user interface arrangements. In one embodiment, the terminal displays an emotion indicator alongside the analytical dashboard so that the user can see that the system has recognized the current emotional state. The terminal can provide controls that allow the user to override the automatically inferred state, such as a slider for “more detail” versus “less detail.” The terminal sends such user overrides to the server, which incorporates them into prompt generation logic.

The user uses the system in a variety of technical applications. For example, the user can be a system operator responsible for controlling configurations of computing infrastructure, and the action plans correspond to maintenance or upgrade actions by external service providers. In such a scenario, the server predicts potential service changes, generates risk assessments for system availability, and instructs the generative AI model to propose reconfiguration sequences for network devices or virtual machines. The visualization data can include dependency graphs showing which components should be migrated or replicated. In this way, the system contributes directly to the control and optimization of computing and network resources, rather than solely to abstract business decision-making.

By integrating detailed feature extraction, structured prediction, generative reasoning via prompt sentences, multimodal emotion estimation, and adaptive visualization into a single cooperative architecture among the server, terminal, and user, the system improves the performance and technical functioning of the underlying computing environment. The system reduces processing latency by reusing structured intermediate results, improves prediction and explanation accuracy through specialized models and prompt design, and lowers communication and computation overhead through adaptive, emotion-aware control of output length and complexity.

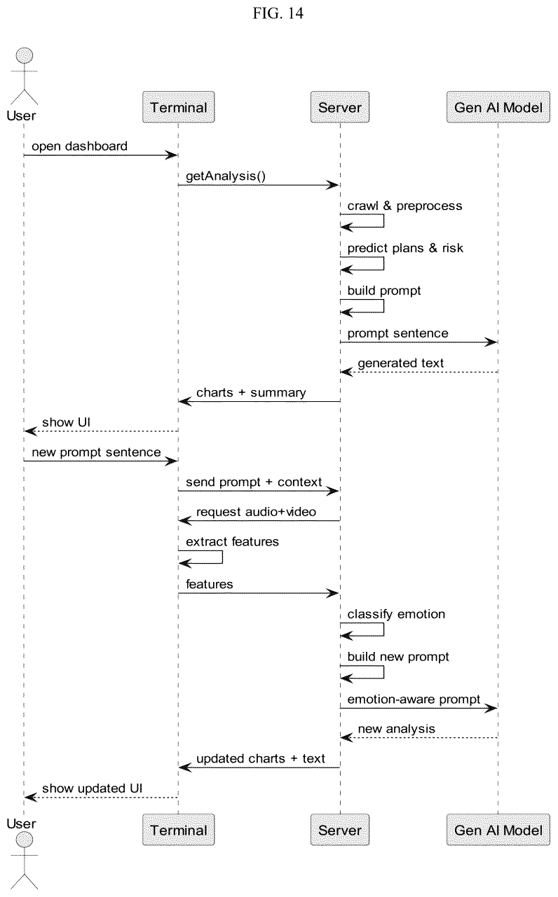

The following describes the processing flow using FIG. 14.

### Step 1

The server acquires document data from an information network.

The server receives as input a list of source identifiers, such as network addresses and query keywords stored in a configuration repository. The server sends HTTP requests via a network interface to these addresses, retrieves responses in formats such as HTML, plain text, or structured records, and writes each response into a storage device as a document record containing at least a source identifier, a timestamp, and a raw content field. The server thereby converts abstract source references into concrete digital document data suitable for further processing.

### Step 2

The server preprocesses the document data into normalized text.

The server uses, as input, the raw content fields of document records stored in the storage device. The server applies parsing operations to strip markup tags, scripts, navigation elements, and boilerplate, and then performs language detection and segmentation into sentences. The server tokenizes each sentence into word tokens, converts characters to a canonical case, removes stopwords, and applies morphological normalization such as lemmatization. The server outputs, for each document record, a cleaned token sequence and a normalized text string linked to the original document identifier.

### Step 3

The server extracts numerical feature information from the normalized text.

The server receives, as input, the cleaned token sequences and normalized text strings associated with document identifiers. The server constructs a vocabulary and computes statistical measures such as term frequency and inverse document frequency over a batch of documents. The server encodes each document as a numerical feature vector, where each dimension corresponds to a weighted term or an embedding coordinate produced by an embedding encoder. The server stores the resulting feature vectors in a feature table together with references to the corresponding document identifiers. Through this data transformation, the server converts unstructured text into machine-learnable feature information.

### Step 4

The server trains a prediction model of action plans using historical data.

The server uses, as input, feature vectors from past documents and associated outcome labels that indicate observed external actions within specified time windows. The server partitions the labeled dataset into training and validation subsets and initializes a machine learning model, such as a neural network or an ensemble of decision trees. The server iteratively computes prediction outputs on mini-batches, calculates a loss value such as cross-entropy between predictions and labels, and updates internal model parameters using a weight update algorithm such as gradient descent or a similar optimization method. The server repeats this data computation until convergence criteria are met and outputs a trained prediction model along with performance metrics, storing the model parameters and a version identifier in a model repository.

### Step 5

The server predicts current and future action plans for external entities.

The server receives, as input, feature vectors for newly processed documents for which no outcome labels exist. The server loads the latest trained prediction model, applies the model to the input feature vectors, and calculates output probabilities over predefined action plan categories for each external entity. The server derives predicted labels by selecting the highest probability category and computes confidence values and expected time windows by combining model outputs with temporal metadata. The server writes, as output, prediction records including entity identifiers, predicted action plans, probabilities, and time windows into a prediction table.

### Step 6

The server evaluates risks associated with predicted action plans.

The server uses, as input, the prediction records containing predicted action plans and probabilities, along with impact parameters stored in configuration data structures for each action type and entity. The server calculates a risk score for each prediction by applying a risk evaluation function that combines probability and impact, such as a product or weighted sum. The server classifies risk levels into categories such as low, medium, and high, according to threshold rules. The server outputs updated prediction records enriched with risk scores and risk levels, and stores them in the prediction table for downstream processing.

### Step 7

The server constructs a context summary for prompt sentence generation.

The server receives, as input, the enriched prediction records and a selection criterion such as a time range or a target set of entities. The server filters the prediction table based on the criterion, orders the selected records by risk score or recency, and condenses them into a structured context representation. The server formats this representation as human-readable bullet points or sentences that summarize, for each entity, the predicted action plans, probabilities, risk levels, and expected timing. The server outputs a context text block that is suitable to be incorporated into a prompt sentence.

### Step 8

The server generates a prompt sentence for a generative AI model.

The server uses, as input, the context text block generated in Step 7 and internal rules describing desired analysis tasks and output structures. The server composes an instruction section that specifies what analysis the generative AI model should perform and how the response should be organized, for example by defining required sections and requested content types. The server concatenates the context section and the instruction section into a single prompt sentence. The server outputs this prompt sentence as a sequence of textual tokens and forwards it to a generative AI interface module for inference.

### Step 9

The server invokes the generative AI model and obtains generated content.

The server receives, as input, the prompt sentence and parameter settings such as maximum length, sampling temperature, and sampling strategy. The server encodes the prompt sentence into token identifiers and transmits them to a generative AI model implemented as a neural network, for example a transformer-based sequence model. The generative AI model processes the tokens, computes attention-based hidden representations, and outputs successive token probabilities from which the server samples or selects output tokens according to the configured strategy. The server decodes the output token sequence into a natural language response text comprising scenario analysis, risk explanation, and recommended actions. The server outputs this response text for further structuring.

### Step 10

The server structures the generated response into machine-usable data.

The server uses, as input, the response text produced by the generative AI model. The server applies pattern recognition rules to detect section headings, lists, and key phrases, and splits the text into logical segments such as scenario descriptions and action recommendations. The server maps each segment into fields of a predefined data schema, assigning entity identifiers, action categories, time horizons, and priority levels where indicated or inferable. The server outputs structured records representing the generative analysis and stores them in a scenario table associated with related prediction records.

### Step 11

The server generates visualization data from prediction and scenario records.

The server receives, as input, prediction records containing probabilities, risk scores, and timing information, together with structured scenario records holding recommended actions and their priorities. The server aggregates numerical values over dimensions such as time, entity, and action category to obtain time-series points, distributions, and hierarchical relationships. The server constructs visualization data structures that specify chart types, axes, labels, and data points for representations such as line charts of risk over time, bar charts of risk per entity, and hierarchical diagrams of action plans and associated countermeasures. The server outputs these visualization data structures and transmits them to the terminal over the information network.

### Step 12

The terminal renders visualization data and narrative explanations to the user.

The terminal receives, as input, the visualization data structures and structured scenario records from the server. The terminal uses a graphical user interface library to allocate display regions, generate drawing commands for charts based on the provided axes and data points, and render interactive elements such as tooltips and filters. The terminal retrieves narrative fields from scenario records and displays them in textual panels aligned with relevant visualizations. The terminal outputs a composite user interface on the display device, enabling the user to view and interact with both graphical and textual analysis.

### Step 13

The user reviews analysis results and issues an additional prompt sentence.

The user uses, as input, the displayed charts and narrative explanations provided by the terminal. The user interprets the information, decides that further exploration is needed, and enters a new natural language instruction through a text input field or by speaking into a microphone. For example, the user can input a prompt sentence such as “Using the latest competitor trend data, predict how Entity A will react if we reduce our prices by 10% next month, and suggest a defensive strategy that minimizes profit loss.” The terminal converts any spoken input into text as needed, and outputs the user's prompt sentence together with context information such as the current screen state to the server for further processing.

### Step 14

The terminal captures voice and image data of the user for emotion estimation.

The terminal receives, as input, real-time signals from a microphone and a camera when the user interacts with the system. The terminal samples the audio stream into frames, extracts acoustic features such as pitch, energy, spectral characteristics, and speaking rate, and buffers these features. The terminal simultaneously captures image frames of the user's face, applies face detection and facial landmark detection procedures, and computes facial features such as mouth curvature, eye openness, and eyebrow positions. The terminal outputs audio feature vectors and facial feature vectors, along with timestamps and session identifiers, to the server for emotion analysis.

### Step 15

The server estimates the user's emotional state from multimodal features.

The server uses, as input, the audio and facial feature vectors received from the terminal. The server feeds these vectors into an emotion classification model, such as a neural network with input units for concatenated features, hidden layers with nonlinear activation functions, and an output layer representing emotional categories. The server computes output probabilities over emotional states and selects the most likely emotional label, such as “calm,” “stressed,” or “confused.” The server outputs the estimated emotional state and records it as context data associated with the current user session.

### Step 16

The server adjusts prompt sentence generation based on the emotional state.

The server receives, as input, the estimated emotional state, the user's additional prompt sentence from Step 13, and the current context summary from prediction and scenario data. When the emotional state indicates stress or overload, the server modifies prompt construction rules to request shorter, simpler, and more reassuring responses. When the emotional state indicates confidence or high expertise, the server modifies the rules to request more detailed and technical content. The server composes a new combined prompt sentence that embeds the updated instruction style, includes the user's specific question, and incorporates the latest prediction context. The server outputs this emotion-aware prompt sentence and sends it to the generative AI model as described in Step 9, thereby closing the adaptive loop and enabling further iterative analysis.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

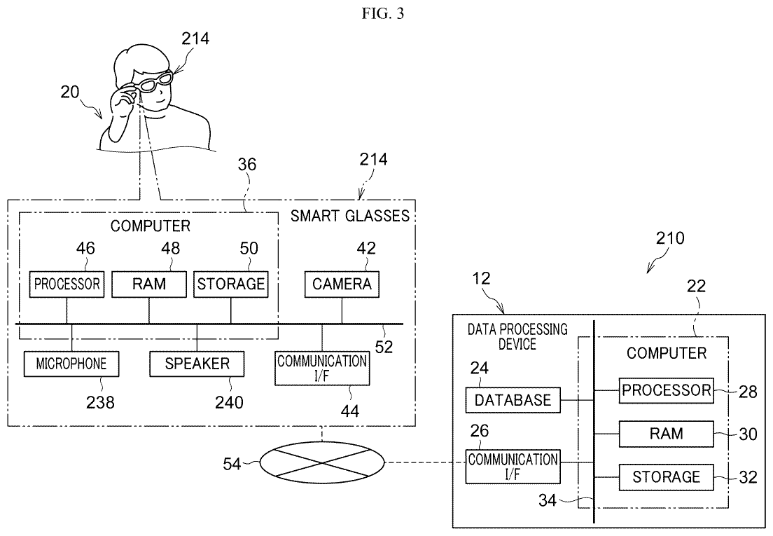

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

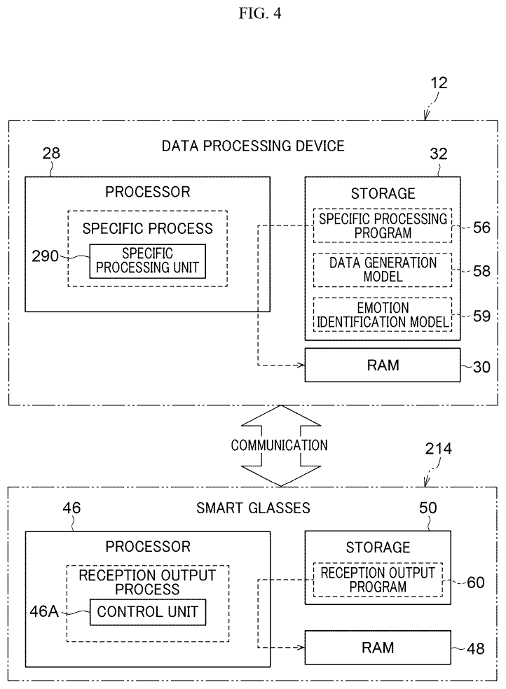

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

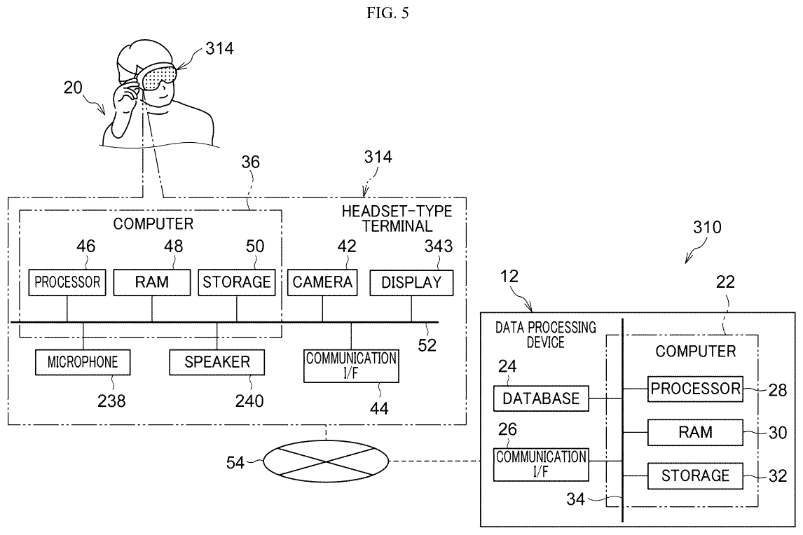

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

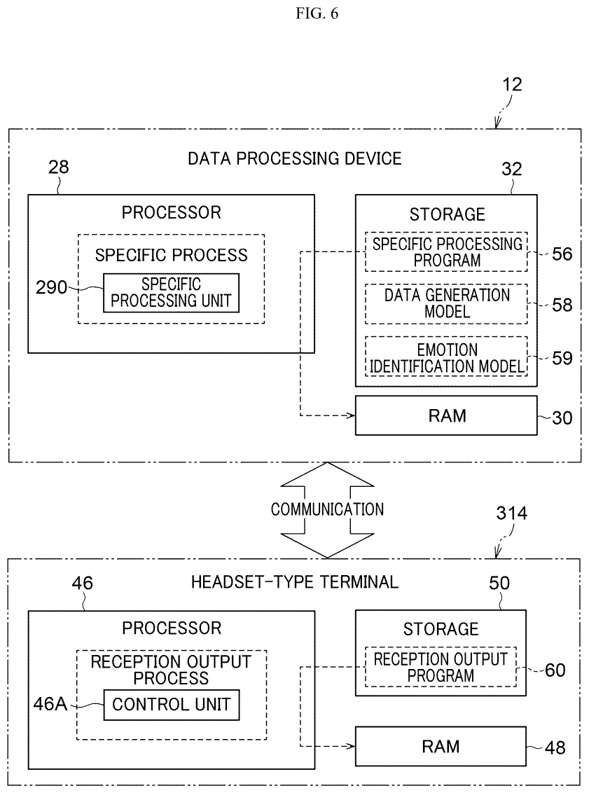

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

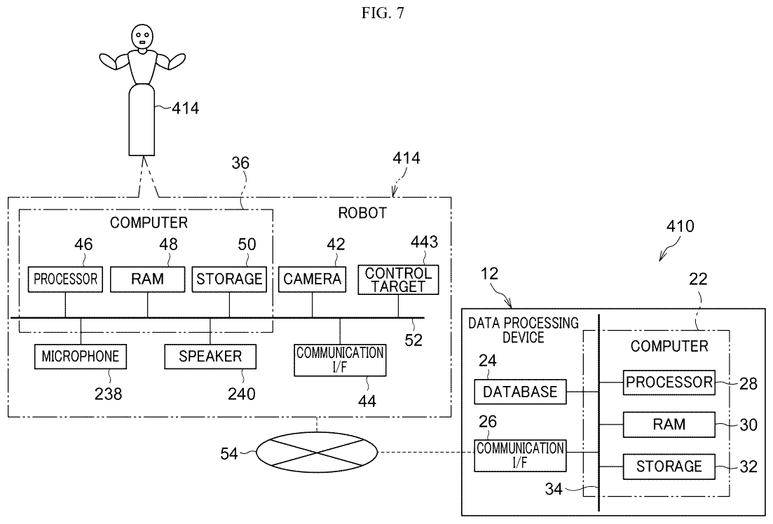

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

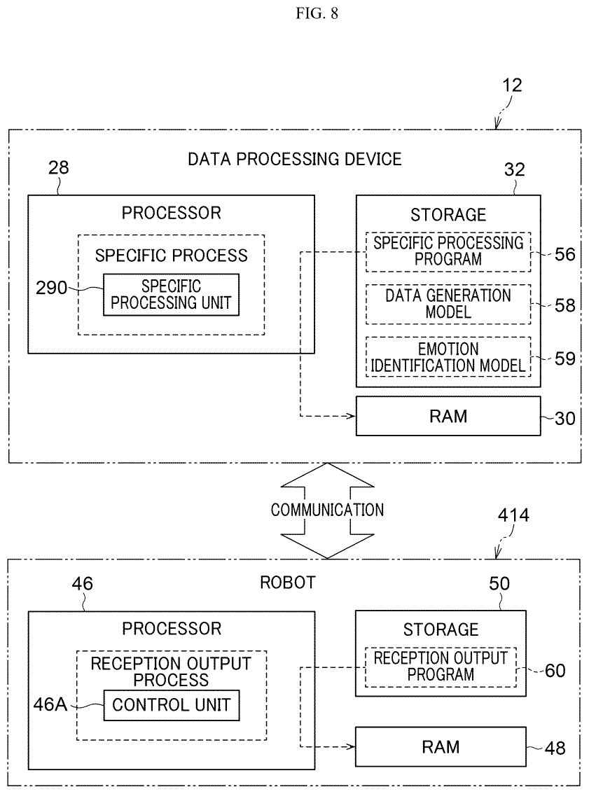

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

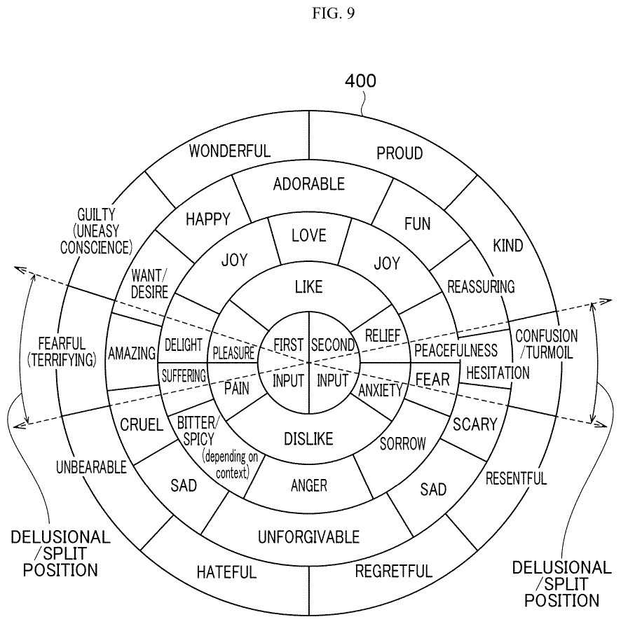

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

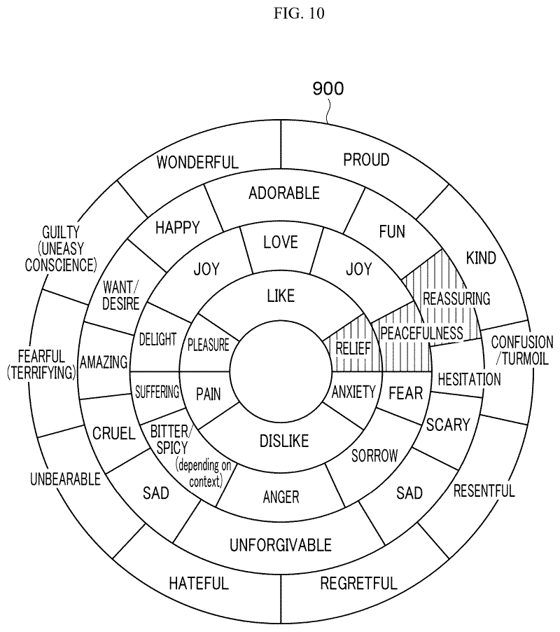

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a terminal, identification information of an information acquisition target and analysis conditions for collecting public information over an information communication network, and collect the public information by executing an information searching process that operates automatically based on the analysis conditions,
perform text analysis processing and natural language processing on the collected public information to remove unnecessary information, extract useful information corresponding to a predetermined period and a predetermined topic, and convert the extracted useful information into structured data suitable for machine learning processing,
calculate, based on the structured data, a plurality of candidate future actions of another entity and an occurrence probability corresponding to each candidate future action by using a trained prediction model, and generate prediction information for specifying an attack plan of the other entity,
generate, based on the prediction information and the analysis conditions, an input sentence including a prompt sentence for causing a generative information processing model to predict the attack plan of the other entity in advance, transmit the input sentence to the generative information processing model, and acquire explanation text information or strategy proposal information from the generative information processing model, and
generate, based on the prediction information and the explanation text information or the strategy proposal information, visualization data according to time information, the other entity, or an action type, and output display screen data accessible from the terminal.

### Supplementary 2

The system according to supplementary 1,
wherein the processor is configured to
classify the public information, in the natural language processing-based filtering, based on a plurality of topic words and time conditions included in the analysis conditions, automatically generate input features for the prediction model from classification results of the public information, and dynamically update the prompt sentence to reflect the classification results.

### Supplementary 3

The system according to supplementary 1,
wherein the processor is configured to
acquire evaluation information or correction instruction information from a user with respect to the prediction information and the explanation text information or the strategy proposal information obtained from the generative information processing model, store the evaluation information or the correction instruction information as learning data for the prediction model and a prompt sentence generation process, perform relearning based on the learning data, and
execute feedback processing for continuously improving prediction accuracy of the attack plan of the other entity and suitability of the prompt sentence for the generative information processing model.

### Application Example 1

### Supplementary 1

A system comprising a processor,
wherein the processor is configured to
execute an information collection program to acquire document information as public information on an information communication network,
execute a natural language processing program on the acquired document information to perform preprocessing including morphological analysis, term extraction, removal of unnecessary terms, and feature generation, and to filter the document information as competitor trend data,
execute a machine learning program based on the competitor trend data to input the competitor trend data into a prediction model and to generate attack plan information including a prediction result regarding a future behavioral strategy of a competitive entity and confidence information associated with the prediction result,
generate, based on the attack plan information and the competitor trend data, a prompt sentence for causing a generative artificial intelligence model including a generative language model to perform advance prediction of an attack plan and to generate an explanatory text regarding a reason and an impact of the attack plan, input the prompt sentence into the generative artificial intelligence model, and obtain explanation information in natural language from the generative artificial intelligence model,
store the attack plan information and the explanation information as structured data in a storage device and transmit the structured data to a client device, and
determine importance based on the confidence information and impact information included in the attack plan information and extract attack plan information that satisfies a predetermined condition as important attack plan information to generate notification data.

### Supplementary 2

The system according to supplementary 1,
wherein the processor is configured to, when acquiring the document information, use, as setting information, target entity information, classification information, and time interval information to select an acquisition target, and further to filter the document information in the natural language processing program based on specific phrase information, thereby efficiently collecting the public information on the information communication network.

### Supplementary 3

The system according to supplementary 1,
wherein the processor is configured to execute a learning process on the prediction model using a historical data set including previously collected competitor trend data, corresponding actual behavioral results, and the explanation information obtained from the generative artificial intelligence model, and to perform a feedback process that updates the prediction model and a generation process of the prompt sentence based on a difference between the attack plan information and the actual behavioral results, thereby improving prediction accuracy and suitability of explanatory content.

### Example 2

### Supplementary 1

A system comprising a processor,
wherein the processor is configured to
acquire target information by executing an automated acquisition process to collect public information over an information communication network,
convert the target information into structured data, perform preprocessing including missing-value completion and numerical-value normalization, and generate a learning dataset,
train a prediction model based on the learning dataset by using a statistical learning algorithm or a machine learning algorithm, and generate a trained prediction model,
input newly acquired information into the trained prediction model, calculate a prediction result regarding an action plan of another party, and generate prediction data representing the prediction result,
construct a prompt sentence, for causing a generative information processing model to preliminarily predict an attack plan or an action plan, based on the prediction data and summary history information used to generate the prediction data,
input the prompt sentence into the generative information processing model and receive an analysis result in natural language obtained from the generative information processing model, and
convert the prediction data and the analysis result into visualization data and generate visualization information in a format outputtable to a display device.

### Supplementary 2

The system according to supplementary 1,
wherein the processor is configured to
select the public information based on a predetermined search term or classification information at the time of collecting the target information, and efficiently extract information to be included in the learning dataset.

### Supplementary 3

The system according to supplementary 1,
wherein the processor is configured to
calculate an accuracy index of the prediction by comparing the prediction data with actual event data, and periodically or conditionally execute feedback processing to update the learning dataset and the prediction model based on the accuracy index.

### Application Example 2

### Supplementary 1

A system comprising a processor,
wherein the processor is configured to
collect public information on an information network by executing a crawling acquisition unit that accesses multiple information sources and acquires document data,
preprocess the acquired document data by executing a preprocessing unit that applies natural language processing and statistical processing to convert the document data into feature information, including tokenization, normalization, removal of noninformative elements, and
transformation into numerical feature vectors,
build a prediction model of action plans of external entities by executing a learning and prediction unit that uses the feature information and past outcome information to train a prediction model and to estimate current and future action plans and associated risk evaluations,
generate and input a prompt sentence to a generative artificial intelligence model by executing a prompt generation and input unit that, based on the estimated action plans and the risk evaluations, constructs an instruction sentence to instruct the generative artificial intelligence model to perform detailed analysis of the action plans and to generate countermeasures, and then inputs the instruction sentence into the generative artificial intelligence model,
structure output from the generative artificial intelligence model by executing a result structuring unit that converts explanation sentences and proposal contents output from the generative artificial intelligence model into structured data, associates the structured data with temporal information and entity information, and stores the structured data,
generate display data by executing a display data generation unit that, based on the structured data, generates visualization data indicating occurrence probabilities, impact levels, and
timing of the action plans, and transmits the visualization data to a terminal device, and
estimate an emotional state of a user and feed back emotional-state information by executing an emotion estimation and feedback unit that uses voice information and image information acquired from the terminal device to estimate the emotional state of the user and that feeds back the emotional-state information as context information to the prompt generation and input unit so as to dynamically adjust contents and response style of instructions to the generative artificial intelligence model.

### Supplementary 2

The system according to supplementary 1,
wherein the processor is configured to
generate, by the display data generation unit, time-series graphs, distribution diagrams, and hierarchical structure diagrams indicating, based on the structured data, occurrence probabilities by type of action plan, risk levels by time period, and impact degrees by entity,
and to perform visualization control such that the terminal device interactively displays the visualization data.

### Supplementary 3

The system according to supplementary 1,
wherein the processor is configured to
apply, by the emotion estimation and feedback unit, an emotion classification model to audio features and facial features acquired from the terminal device, to estimate the emotional state of the user, and, in accordance with the estimated emotional state, to change a degree of detail, a level of technicality, and an expression style of the instruction sentence generated by the prompt generation and input unit, and to control a length, a structure, and a tone of the response output from the generative artificial intelligence model.

What is claimed is:

1. A system comprising:
circuitry configured to:
receive, via a communication interface coupled to a packet-switched network, identification data and analysis conditions from a terminal device, and automatically collect public information via an information communication network based on the analysis conditions;
perform text analysis processing and natural language processing on the collected public information to remove noise and extract useful information corresponding to predetermined temporal and topical conditions, and convert the extracted useful information into structured data suitable for machine learning processing;
classify the public information based on the analysis conditions and generate input features from classification results;
calculate, using a trained prediction model and based on the structured data and the input features, a plurality of candidate action items and an occurrence probability corresponding to each candidate action item, to generate prediction information;
generate, based on the prediction information, the classification results, and the analysis conditions, a dynamically updated prompt sentence for input to a generative neural network model;
transmit the prompt sentence to the generative neural network model, acquire explanation text or strategy proposal text from the generative neural network model, and generate visualization data based on the prediction information and the explanation text; and
acquire user evaluation data or correction instruction data from the terminal device, store the acquired data as learning data, and update parameters of the prediction model and a prompt sentence generation algorithm based on the learning data.

2. The system according to claim 1, wherein the circuitry is configured to perform the natural language processing on the collected public information by applying a tokenization model, a stop-word filter, and a keyword extraction algorithm to extract useful information matching the analysis conditions, and to convert the extracted useful information into structured data by applying a vectorization transformation to generate a numerical feature matrix.

3. The system according to claim 2, wherein the circuitry is configured to apply a term frequency-inverse document frequency weighting to the keyword extraction, and to generate the numerical feature matrix by encoding extracted keywords as sparse feature vectors indexed by vocabulary position.

4. The system according to claim 2, wherein the identification data comprises an entity identifier of a subject organization, the analysis conditions comprise topic keywords and a temporal filter, and the candidate action items comprise predicted strategic actions of the subject organization.

5. The system according to claim 4, wherein the prediction information specifies a predicted competitive action plan of the subject organization, and the explanation text comprises a natural language explanation of the predicted action plan generated by the generative neural network model.

6. The system according to claim 1, wherein the circuitry is configured to calculate the occurrence probability by applying the trained prediction model to the input features using a probabilistic classification algorithm that outputs a probability distribution over the plurality of candidate action items, and to rank the candidate action items in descending order of occurrence probability.

7. The system according to claim 6, wherein the circuitry is configured to generate the visualization data by constructing a probability-ranked list of candidate action items with corresponding occurrence probability values, and to generate display screen data encoding the visualization data for transmission to the terminal device via the communication interface.

8. The system according to claim 1, wherein the circuitry is configured to generate the dynamically updated prompt sentence by constructing a prompt template that encodes the prediction information including the ranked candidate action items and occurrence probabilities, the classification results, and the analysis conditions as structured fields, and by applying a prompt optimization algorithm to select prompt components based on a relevance metric.

9. The system according to claim 8, wherein the circuitry is configured to apply the prompt optimization algorithm by evaluating a set of candidate prompt components against a prompt quality metric derived from the learning data, and selecting the prompt components that maximize the prompt quality metric.

10. The system according to claim 1, wherein the circuitry is configured to update the parameters of the prediction model by applying a supervised learning algorithm to the learning data comprising labeled correction instruction data, and to update the prompt sentence generation algorithm by adjusting template weights based on correspondence between user evaluation data and generated explanation text.

11. The system according to claim 10, wherein the circuitry is configured to apply a gradient-based optimization algorithm to compute parameter updates for the prediction model using a loss function that measures divergence between predicted occurrence probabilities and ground-truth labels derived from the correction instruction data.

12. The system according to claim 1, wherein the circuitry is configured to classify the public information by applying a multi-class text classifier that assigns each piece of public information to one of a plurality of topic categories corresponding to the analysis conditions, and to generate the input features by computing a category frequency vector from the classification results.

13. The system according to claim 12, wherein the circuitry is configured to filter the collected public information before classification by applying a keyword match filter using a keyword list derived from the analysis conditions, and to discard public information that does not match any keyword in the keyword list.

14. The system according to claim 1, wherein the circuitry is configured to automatically collect the public information by executing a web crawling process that transmits HTTP requests to a plurality of uniform resource locators associated with the identification data, and to extract text content from received response data using an HTML parsing algorithm.

15. The system according to claim 14, wherein the circuitry is configured to deduplicate the extracted text content by computing a content hash for each extracted item and discarding items with a content hash matching a previously stored content hash in a deduplication cache.

16. The system according to claim 1, wherein the circuitry is configured to generate the visualization data by encoding the prediction information as a time-series chart representing occurrence probabilities of the candidate action items over a time range derived from the temporal filter, and transmitting the visualization data to the terminal device as display screen data.

17. The system according to claim 1, wherein the circuitry is configured to store the prediction information and the explanation text as a prediction history in the storage device, and to incorporate prior prediction history entries into the dynamically updated prompt sentence to enable iterative refinement of predictions over multiple analysis sessions.

18. A system comprising:
circuitry configured to:
receive, via a communication interface coupled to a packet-switched network, identification data and analysis conditions from a terminal device;
automatically collect public information via an information communication network, apply natural language processing to remove noise and extract useful information, and convert the extracted useful information into structured data;
classify the public information to generate input features, and apply a trained prediction model to the structured data and the input features to compute candidate action items and corresponding occurrence probabilities as prediction information;
construct a dynamically updated prompt sentence encoding the prediction information, the input features, and the analysis conditions, and execute a generative neural network model using the prompt sentence to generate explanation text;
generate visualization data from the prediction information and the explanation text, and transmit display screen data encoding the visualization data to the terminal device via the communication interface; and
acquire user evaluation data or correction instruction data from the terminal device, and update parameters of the prediction model and the prompt sentence generation algorithm based on the user evaluation data or correction instruction data.

19. The system according to claim 18, wherein the circuitry is configured to apply a keyword extraction algorithm and a vectorization transformation to the collected public information to generate a numerical feature matrix, and to apply a gradient-based optimization algorithm to the learning data to update the parameters of the prediction model.

20. A method comprising:
receiving, via a communication interface coupled to a packet-switched network, identification data and analysis conditions from a terminal device, and automatically collecting public information via an information communication network based on the analysis conditions;
performing text analysis processing and natural language processing on the collected public information to remove noise and extract useful information corresponding to predetermined temporal and topical conditions, and converting the extracted useful information into structured data suitable for machine learning processing;
classifying the public information based on the analysis conditions and generating input features from classification results;
calculating, using a trained prediction model and based on the structured data and the input features, a plurality of candidate action items and an occurrence probability corresponding to each candidate action item, to generate prediction information;
generating, based on the prediction information, the classification results, and the analysis conditions, a dynamically updated prompt sentence for input to a generative neural network model;
transmitting the prompt sentence to the generative neural network model, acquiring explanation text or strategy proposal text from the generative neural network model, and generating visualization data based on the prediction information and the explanation text; and
acquiring user evaluation data or correction instruction data from the terminal device, storing the acquired data as learning data, and updating parameters of the prediction model and a prompt sentence generation algorithm based on the learning data.
